(19) United States
(12) Patent Application Publication
(10) Pub. No.: US 2013/0110679 A1
(43) Pub. Date: May 2, 2013

(54) METHOD AND APPARATUS FOR A DESIGNER GARMENT TRACKING PLATFORM

(71) Applicant: D'Marie Group, Inc., (US)

(72) Inventors: Frank SPADAFORA, New York, NY (US); Matt POWELL, Woodinville, WA (US); Amelia OTTE, Brooklyn, NY (US)

(73) Assignee: D'MARIE GROUP, INC.

(21) Appl. No.: 13/625,537

(22) Filed: Sep. 24, 2012

Related U.S. Application Data
(60) Provisional application No. 61/626,198, filed on Sep. 22, 2011.
(60) Provisional application No. 61/659,218, filed on Jun. 13, 2012.

(51) Int. Cl. G06Q 30/06

(52) U.S. Cl. CPC G06Q 30/0627
USPC 705/26.63

(57) ABSTRACT

Described are computer-based methods and apparatuses, including computer program products, for a designer garment tracking platform. A set of garment profiles is received, each garment profile defining a garment being offered for sale by an associated garment designer profile. A set of new stylist projects is received, each including data indicative of one or more garment profiles, a model profile for a model, and a media event. The set of garment profiles is updated based on the received set of new stylist project. Data indicative of a request from a consumer's computing device to view a requested set of garment profiles associated with a particular media event, a particular stylist profile, a particular model profile, a particular garment designer profile, or any combination thereof, is received. A web page to the consumer's computing device comprising data indicative of the requested set of garment profiles.

### RELATED APPLICATIONS

The present application relates to and claims priority under 35 U.S.C. 119(e) to U.S. Provisional Application Nos. 61/659,218 entitled “System and Method for Sharing, Tracking, and Selectively Packaging Clothing and Accessory Samples,” filed on Jun. 13, 2012, and 61/626,198 entitled “Method and Apparatus for Tracking Fashion Clothing and Accessory Samples,” filed on Sep. 22, 2011, the disclosures of which are hereby incorporated by reference herein in their entirety.

TECHNICAL FIELD

The technical field relates generally to computer-based methods and apparatus, including computer program products, for a designer garment tracking platform, and more specifically to a designer garment tracking platform that can track the lifecycle of a garment from the designer, to the stylist, to the media, and to a consumer.

### BACKGROUND

Fashion sample garments are designed, constructed, and produced by a fashion designer or fashion label. These sample garments are displayed as collections of 45-120 looks in various presentations and runway shows to an audience of editors, critics, buyers, and fashion stylists every six months. They are called “samples” because it is the designer's intention to mass produce replicas of the exact garment or accessory for consumer purchase. Essentially, they are the company's ticket to gaining consumer attention and desire through being used by stylists in media projects, with the ultimate goal of increasing consumer sales of the clothes. After the samples are viewed in the presentation, they become available to industry professionals to be used in all media platforms (e.g., film, television, runway, print, magazines, online media, music, etc.) as a form of product placement. Currently, most designers and clothing retailers are unable to fully profit from this product placement because issues like human error, outdated technology, and erratic or incomplete tracking methods run rampant, hindering the fashion labels.

The process by which garments are requested and used is straightforward, yet unregulated and easily mismanaged. Stylists are independently hired by producers and clients who want access to the designers' samples and require other various services offered by stylists. Typically, all stylists have access to the same samples and have to share with one another.

Because of the limited quantity of samples, a stylist submits a “request” to borrow or rent the sample for a limited period of time. In the usual case, the stylist is required to contact the designer directly or interact with a designer's public relations department to coordinate shipping, payment, and care of the samples.

Even when a garment is requested by a stylist, there is no guarantee that it will be used and worn for the project. It is typical for a stylist to request multiple samples from various designers that could be appropriate for the same project. It is the responsibility of the designer to ask the stylist if the designer's sample was the final selection and was used in the project. Designers value this information, known as an “edit credit”, and will attempt to track these credits for future brand promotion and public relation strategies via in-house databases.

While designers have implemented individual methods of how to manage the sharing of sample-garments, they have yet to utilize one industry-wide standard of executing this process. The fashion industry was established before the technology industry, so fashion companies integrating technology is a relatively new concept. Many established fashion houses still function with infrastructure to manage their business tasks with very little use of technology. However, fashion's recent commercialization and globalization due to technology is the very reason these companies now need faster and more accurate digital tools to help them meet consumer demands.

Some websites provide industry-only functions that attempt to assist designers, stylists, and other fashion-based individuals in the garment request process. One example is a tool that enables a user to manage their inventory. Users can manually enter garment information and assign an individual style image or “runway look” snapshot to every garment profile. In some examples, an RFID barcode is generated and printed, which is then placed on the garment for check-in and checkout scanning However, such systems lack a communication platform to share a sample's status between designers and stylists, and is instead, for example, a per office program that only detects the last vague check point status of a garment. Such systems suffer from a lengthy process of manual data entry, lack of detailed tracking information and a “difficult to navigate” user interface. Further, there is no user-generated data that can be compiled into a searchable database for tracking media use, as well as no lifestyle platform for consumers, and therefore no link to e-commerce.

Other examples connect designers, editors, and stylists in an effort to streamline the fashion editing process. Such examples can allow editors to browse hundreds of different items and then initiate requests with details about the shoot, run-through and return dates, as well as the editors and stylists involved. However, such examples only enable private tracking for industry users and don't display any of this information for consumers.

Some examples present consumers with purchasing options (e.g., by aggregating news, articles, and photos focused on the happenings of the fashion world). However, such examples do not provide archive functions that allow consumers to search media projects, etc. for the garments worn. Further, such examples do not offer anything above a basic tool for stylist to create “look books” of their favorite images, which they can then print and share with exterior e-mail accounts. They do no track sample garments whatsoever.

Other examples are consumer-only websites, which provide people with a social network related to fashion (e.g., where users can create profiles to share pictures of style-related things they like and purchase items via 3rd party retailers in their very limited shopping section). Such examples do not offer any garment tracking tools and are often strictly for consumers to engage in fashion-centered digital conversations.

### SUMMARY

Offering consumers more readily available information about fashion trends and identifiable garments worn by celebrities in various media platforms is becoming, itself, a trending market for start-up companies. The disclosed systems and methods herein (often referred to generically as “D'Marie”) provide a process for harvesting accurate and timely information about sample garments. A complete tracking process is provided from the sample-garment's creation through to that garment's purchase by a consumer. The systems and methods disclosed herein provide a single website that combines the fashion industry tools and audience with technology and a consumer-based platform.

The present invention provides a digital platform and database that is available to designers, stylists, industry clients, and consumers. The present invention allows designers to track fashion samples as they are used by stylists and industry clients in traditional and non-traditional media events (e.g., movies, television, advertising, music, red-carpet, etc.) via a unified platform. The present invention also allows consumers to search for and view a garment based on its placement in various media events so that the consumer can then purchase the garment from the designer, or from a third party who has been authorized by the designer to manufacture a version of the garment.

A brief summary of various exemplary embodiments is presented. Some simplifications and omissions may be made in the following summary, which is intended to highlight and introduce some aspects of the various exemplary embodiments, but not limit the scope of the invention. Detailed descriptions of a preferred exemplary embodiment adequate to allow those of ordinary skill in the art to make and use the inventive concepts will follow in the later sections.

In one aspect, a computerized method for providing a fashion platform is featured. The method includes receiving, by a web server, a set of garment profiles, and storing the set of garment profiles in a database, wherein each garment profile defines a garment being offered for sale by an associated garment designer profile. The method includes receiving, by the web server, a set of new stylist projects, wherein each new stylist project is received from an associated stylist's computing device and includes data indicative of one or more garment profiles from the set of garment profiles, a model profile for a model, and a media event. The method includes updating, by the web server, for each new stylist project, each of the one or more garment profiles associated with the new stylist project to reflect data indicative of at least one of the remaining one or more garment profiles associated with the new stylist project, the model profile, the media event, or any combination thereof. The method includes receiving, by the web server, data indicative of a request from a consumer's computing device to view a requested set of garment profiles associated with a particular media event, a particular stylist profile, a particular model profile, a particular garment designer profile, or any combination thereof. The method includes transmitting, by the web server, a web page to the consumer's computing device comprising data indicative of the requested set of garment profiles.

In another aspect, a computerized fashion platform is featured. The computerized fashion platform includes a database, a web server coupled to the database having one or more interfaces configured to provide communication with a set of remote computers, and a processor, in communication with the one or more interfaces and the database. The processor is configured to run a module stored in memory that is configured to cause the processor to receive a set of garment profiles, and storing the set of garment profiles in the database, wherein each garment profile defines a garment being offered for sale by an associated garment designer profile. The module is configured to cause the processor to receive a set of new stylist projects, wherein each new stylist project is received from an associated stylist's computing device and includes data indicative of one or more garment profiles from the set of garment profiles, a model profile for a model, and a media event. The module is configured to cause the processor to update, for each new stylist project, each of the one or more garment profiles associated with the new stylist project to reflect data indicative of at least one of the remaining one or more garment profiles associated with the new stylist project, the model profile, the media event, or any combination thereof. The module is configured to cause the processor to receive data indicative of a request from a consumer's computing device to view a requested set of garment profiles associated with a particular media event, a particular stylist profile, a particular model profile, a particular garment designer profile, or any combination thereof. The module is configured to cause the processor to transmit a web page to the consumer's computing device comprising data indicative of the requested set of garment profiles.

In another aspect, a non-transitory computer readable medium is featured. The non-transitory computer readable medium has executable instructions operable to cause an apparatus to receive a set of garment profiles, and storing the set of garment profiles in a database, wherein each garment profile defines a garment being offered for sale by an associated garment designer profile. The non-transitory computer readable medium has executable instructions operable to cause an apparatus to receive a set of new stylist projects, wherein each new stylist project is received from an associated stylist's computing device and includes data indicative of one or more garment profiles from the set of garment profiles, a model profile for a model, and a media event. The non-transitory computer readable medium has executable instructions operable to cause an apparatus to update for each new stylist project, each of the one or more garment profiles associated with the new stylist project to reflect data indicative of at least one of the remaining one or more garment profiles associated with the new stylist project, the model profile, the media event, or any combination thereof. The non-transitory computer readable medium has executable instructions operable to cause an apparatus to receive data indicative of a request from a consumer's computing device to view a requested set of garment profiles associated with a particular media event, a particular stylist profile, a particular model profile, a particular garment designer profile, or any combination thereof. The non-transitory computer readable medium has executable instructions operable to cause an apparatus to transmit a web page to the consumer's computing device comprising data indicative of the requested set of garment profiles.

In one embodiment, the digital platform and database can provide consumers with similar garments and/or suggest accessories that might go with the viewed garment.

In another embodiment, the digital platform and database allows consumers to customize their own profile pages with various preferences (stylists, garments, models, companies, etc.), as well as various purchases.

In yet another embodiment, the personal profile pages and their corresponding content can be connected to personal accounts within other social media outlet sites.

In another embodiment, the digital platform and database provides profile pages for particular garments and projects, which can host marketplace and advertising opportunities for companies to sell goods that appear in the project.

In yet another embodiment, the digital platform may be networked and accessed through an Internet-based website, and can be accessed via a secure log-in by each unique user. The users may be identified by profile types created within the digital platform, such as: designer, stylist, client, and consumer. Each profile can contain management tools designed to contain a user's unique information and assist the user quickly and accurately through the process of requesting, acquiring, tracking, and purchasing garment samples in a variety of media projects.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other aspects, features, and advantages of the present invention, as well as the invention itself, will be more fully understood from the following description of various embodiments, when read together with the accompanying drawings.

FIG. 1 illustrates an exemplary embodiment of the overall flow of information through the D'Marie system;

FIG. 2 illustrates an exemplary embodiment of the overall system that a user encounters when accessing the website;

FIG. 3 illustrates an exemplary embodiment of a settings page for users, which can collect personal user data to display across the user profile;

FIG. 4 illustrates an exemplary embodiment of a page that allows a primary account user to limit a sub-users' permissions on their primary account;

FIG. 5 illustrates an exemplary embodiment of the designer dashboard, which is the landing page for a designer computer when logged into the system;

FIG. 6 illustrates an exemplary embodiment of a computerized method for creating a collection and uploading the garments to the industry system's garment database;

FIG. 7 illustrates an exemplary embodiment of the stylist dashboard, the landing page for a stylist computer logged into the system;

FIG. 8 illustrates an exemplary embodiment of the brand dashboard, which is the landing page for a brand computer logged into the system;

FIG. 9 illustrates an exemplary embodiment of the calendar system on the platform;

FIG. 10 illustrates an exemplary embodiment of a form for creating a garment profile;

FIG. 11 illustrates an exemplary embodiment of the garment database available on the industry server of the website;

FIG. 12 illustrates an exemplary embodiment of the new project form.

FIG. 13 illustrates an exemplary embodiment of the master pullsheet system;

FIG. 14 illustrates an exemplary embodiment of the custom pullsheet form;

FIG. 15 illustrates an exemplary embodiment of the certified look custom pullsheet form;

FIGS. 16A-B illustrate an exemplary embodiment of the shipping process and approved request messaging system between a designer profile and a stylist profile;

FIG. 17 illustrates an exemplary embodiment of a garment request message;

FIG. 18 illustrates an exemplary embodiment of the messaging system;

FIG. 19 illustrates an exemplary embodiment of the industry platform network connections system between two company profiles;

FIG. 20 illustrates an exemplary embodiment of the contact page/address book that allows industry users to search for and message the contacts in their network;

FIG. 21 illustrates an exemplary embodiment of the garment profile status system;

FIG. 22 illustrates an exemplary embodiment of the garment management overview section of designer and stylist profiles;

FIG. 23 illustrates an exemplary embodiment of a project center inbox database for a user to manage the projects that they are involved with;

FIG. 24 illustrates an exemplary embodiment of an open project page that is a source for stylists to refer back to in terms of their current projects;

FIG. 25 illustrates an exemplary embodiment of a computerized method for closing a project in the platform;

FIG. 26 illustrates an exemplary embodiment of a final production form;

FIG. 27 illustrates an exemplary embodiment of the process of closing a certified look custom pullsheet form within the final production form;

FIG. 28 illustrates an exemplary embodiment of a brand profile on the lifestyle platform;

FIG. 29 illustrates an exemplary embodiment of the consumer lifestyle profile that a consumer user sees upon logging into the system from the lifestyle website;

FIG. 30 illustrates an exemplary embodiment of a designer's public profile page on the lifestyle platform;

FIG. 31 illustrates an exemplary embodiment of a stylist profile on the lifestyle platform;

FIG. 32 illustrates an exemplary embodiment of web pages displayed during an archive process;

FIG. 33 illustrates an exemplary embodiment of a product carousel advertising opportunity;

FIG. 34 illustrates an exemplary embodiment of the blog;

FIG. 35 illustrates an exemplary embodiment of the public database on the lifestyle website and the tag recognition of user inquiries;

FIG. 36 illustrates an exemplary embodiment of the public database user interface on the lifestyle website and a user's search capabilities;

FIG. 37 illustrates an exemplary embodiment of a project page;

FIG. 38 illustrates an exemplary embodiment of the platform home page for the lifestyle platform; and

FIG. 39 illustrates an exemplary embodiment of a garment profile on the lifestyle platform.

### DETAILED DESCRIPTION

The systems and methods disclosed herein provide a platform that encompasses the tremendous amount of data, the technically specific features of user's needs, and the network ability to track these garment's on their business-to-business (B2B) to business-to-consumer (B2C) lifelines without interruption. A garment can include, for example, a piece of clothing, shoes, accessories, and/or anything else that can be worn. The platform can accurately digitize and enhance existing sample-garment tracking methods. Further, the dual consumer/business platform structure attains and distributes information quickly, enabling designers to attain new data about the demographic, psychographic, and geographic composition of the audiences who are viewing their garment in media.

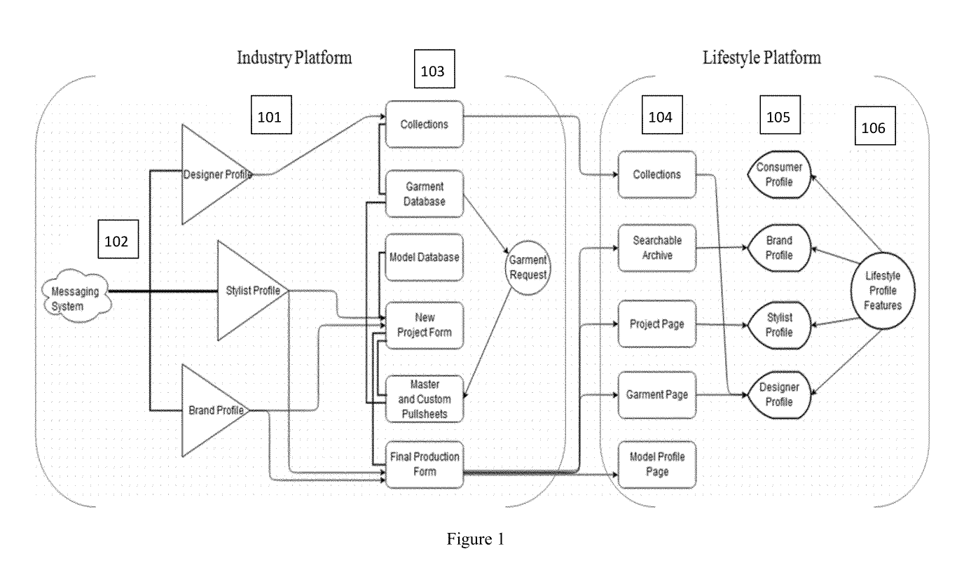

FIG. 1 is an exemplary embodiment of the overall flow of information through the D'Marie system; it depicts the transfer of information from the various points and displays the basic user profile page relationships throughout the platforms. The profile types (101) are the initial input for data into the system and rely on the designer, stylist, or brand users. The messaging system (102) is an over-arching system between all three profile types that enables communication and the transfer of data from user profile to another. The industry system (103) includes several forms and databases that enable the garment request process and project production process through the sequential flow of information. Through the completion of these processes, information is distributed to the lifestyle system. The databases of the lifestyle platform (104) are where data generated from industry users resides and is then disseminated to public pages and profiles. These public profiles (105) provide user interfaces viewable by consumers and other industry users, and formally display both the data generated by the media projects, as well as information that the user has input into their lifestyle profile fields (106).

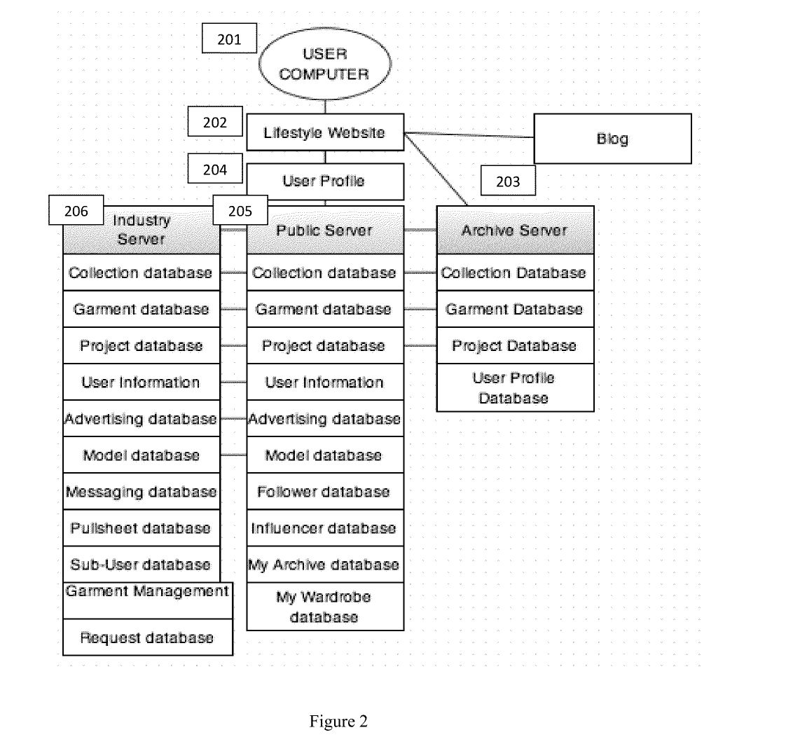

FIG. 2 is an exemplary embodiment of the overall system that a D'Marie user encounters when accessing the website. The user computer (201) can be a consumer, stylist, designer, or brand, and reaches the website by initially accessing www.dmariearchive.com via a web browser. The user arrives at the D'Marie lifestyle website (202) and can access a certain set of public information without logging into their account (203). If the user has an existing user profile with D'Marie they will be able to sign in (204). From the user profile, all account types are able to reach the Public Server, or web server (205). The Public Server includes databases with information generated by the Industry Server (206). The Industry Server (206) is accessible only by industry users who, once logged into their public profile, can reach their corresponding industry profile via the toolbar link. The Industry Server (206) encompasses many features for the user including the creation of collections, the search and request of garments, the creation and completion of projects, and the publishing and crediting of projects. Select industry users also have access to advertisement management and garment management sections once logged in.

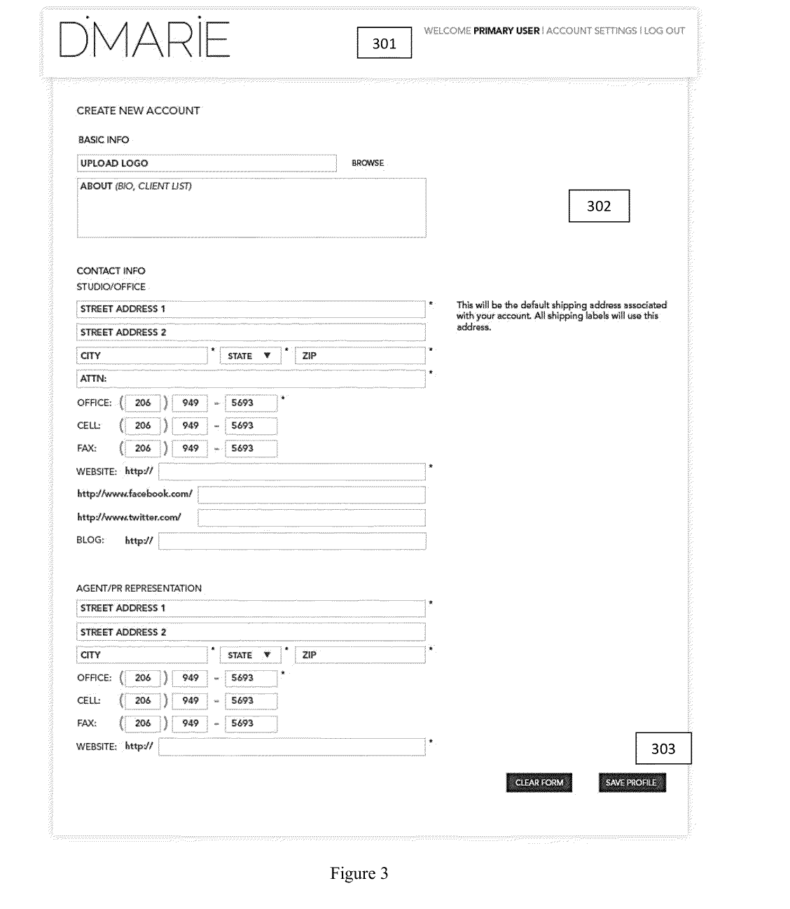

FIG. 3 is an exemplary embodiment of the settings page for users, which can collect personal user data to display across the user profile. Once the user has signed into their account, the user name will appear in bold font (301). This verifies that the user is signed in and can update their personal data. This form is composed of several free form and pull-down fields that a user fills with contact information, social media links, and all other company data (302). After completing the form the user can choose to clear or save information by selecting (303). Once this information is saved, it is generated into several sections of their profile, though the user is able to come to this page and revise the entries at any time.

### INDUSTRY

The Industry portion of the D'Marie website is strictly used by designers, stylists, and brands (companies producing media projects). The platform enables the users to interact in such a way that all functions necessary to the garment request process are aggregated in one simple management system. Each type of industry profile has a “Dashboard” with the functions pertinent to their system abilities prominently displayed. The many features of industry profiles are detailed in the below sections.

### Industry Profile Types

Designer

Designers create collections of garments or jewelry and then upload the content to D'Marie's garment database. Once their garment is entered into the database, designers can manage requests from stylists as well as publish collections and have their garments featured on the lifestyle platform.

FIG. 5 depicts the Designer Dashboard, which is the landing page for a designer computer when logged into D'Marie. From here the designer will be able to view and manage any new activity on their account. A toolbar (501) is displayed so the designer can easily switch between applications and seamlessly view other components of their profile. The (502) interface will display pending project/garment requests from other users within the network. This dashboard displays the most recent requests in bold and displays them in ascending order from newest to oldest. When a request is clicked, the user will be taken to the request inbox by which they can respond to given request. The messages section (503) of the dashboard will display direct messages from other users in their network. Message subjects in bold font indicate that the message has not been read. When the message is clicked, the user will be taken to the message inbox by which they can respond to the message. (504) Previously entered user collections from a user's collection database will appear in this section. The scroll allows the user to view all of their collections from this dashboard. When clicked, the user will be directed to that specific collection and can then edit, add or delete garments. This section (505) shows individual garment profiles from the garment database according to their status. Individual garments profiles can be selected to execute an action according to the status directly within this section.

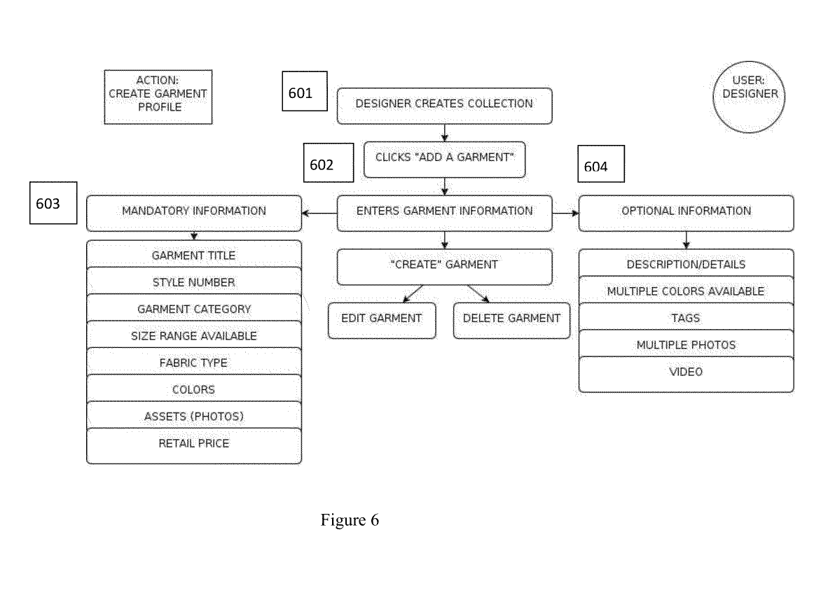

FIG. 6 is an exemplary embodiement of a designer creating a collection and uploading the garments to the industry system's garment database. Initially, a designer user will use the tool, “Create a Collection” to provide collection type, season, year and description (601). Once the collection has been created, uploading garments one by one will be done using the “Add a Garment” tool (602), which includes entering mandatory information regarding the defining features of the garment (603). Several additional options are provided (604), such as garment colors or descriptive tags, which will propery tag a garment profile.

Stylist

Stylists are employed by clients producing media projects, in which case they are responsible for styling and outfitting the characters, or by celebrities to style them for various events. On D'Marie's industry platform they are able to make network connections with designers and clients in order to use garments from designers to complete projects for the companies or celebrities who are commissioning their services.

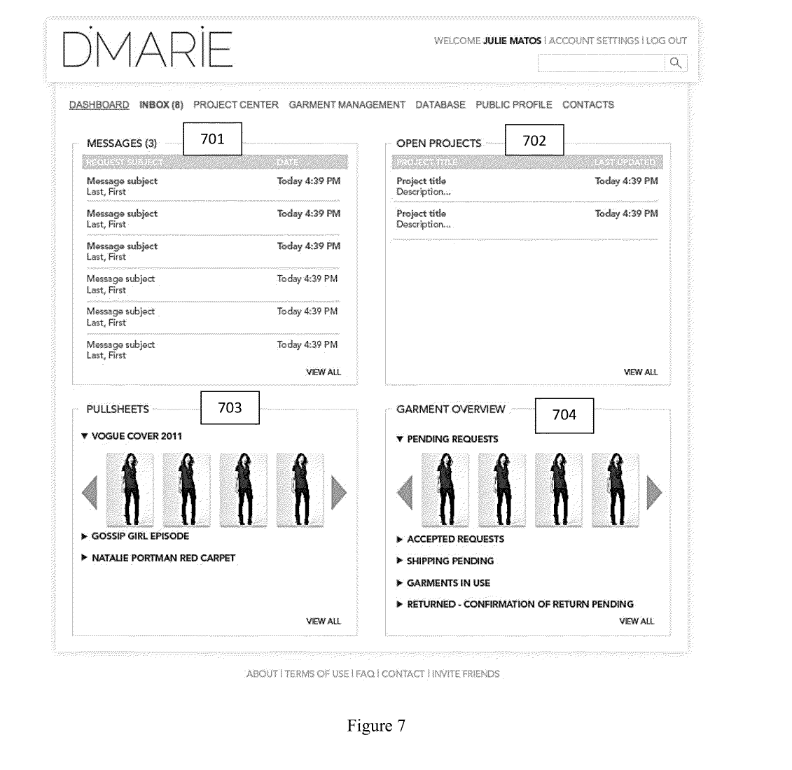

FIG. 7 depicts the Stylist Dashboard, the landing page for a stylist computer logged into D'Marie. From here, the stylist will be able to view and manage all activity on their industry and lifestyle account. (701) This section displays all messaging features including custom messages, network requests, garment requests, edit credit notifications and more from other user profiles. This section displays the most recent messages in ascending order, with all unread messages in bold font. When a message is clicked, the user will be taken to the message inbox by which they can respond to given message. (702) The section titled “Open Projects” displays the recent open projects from the user's project database. When a user clicks on a project they are taken to the project view. The section titled “Pullsheets” (703) allows the user to scroll through all master and custom pullsheets within their pullsheet database that they have created for any project. The section (703) shows individual garment profiles from the garment database according to their status. Individual garments profiles can be selected to execute an action according to the status directly within this section.

Brand

Brands are the producers of media projects who are commissioning a stylist to outfit their characters. They will benefit from the additional accessibility that D'Marie will give their media projects as well as the new advertising opportunities they will be able to utilize on their public profiles.

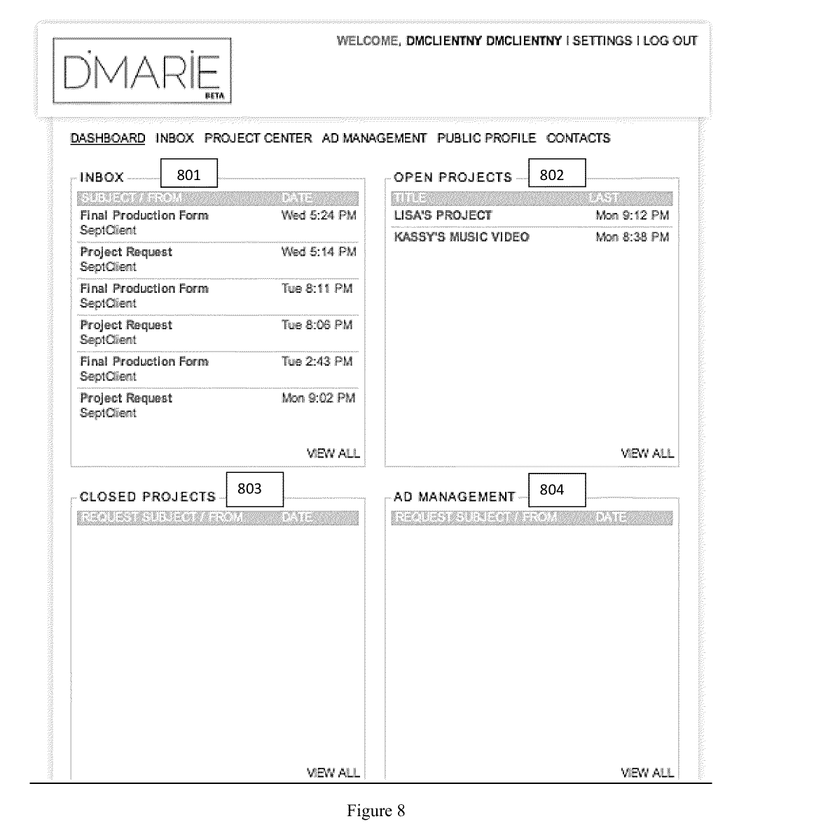

FIG. 8 depicts the Brand Dashboard, which is the landing page for a brand computer logged into D'Marie. From here the company representative will be able to view and manage all activity on their industry and public account. (801) This section displays all recent messages from the messaging database including custom messages, network requests, project requests, edit credit notifications and more from other user profiles. This section displays the most recent messages in ascending order, with all unread messages in bold font. When a message is clicked, the user will be taken to the message inbox by which they can respond to given message. (802) This section of the user's dashboard displays a list of approved open projects from the project database for the brand, along with when they were last updated. When clicked, the user will be directed to the project page. Only projects that have approved project request forms will be displayed here. (803) This area of the dashboard will display projects from the project database that have been closed by the client. The user can continue to view and add data these projects. The ad management section (804) enables users to purchase, create, and distribute advertising on their public profile pages, project pages, and garment pages.

### Industry Features

Sign-Up

D'Marie requires industry users to register for a complimentary profile in order to take advantage of the website's services and features. The sign-up process is simple but comprehensive. After selecting a specific profile type (e.g. designer, stylist, company, etc.) users can fill out information not only about themselves but also their business and shipping information, in order to make future processes more streamlined.

Sub-Users

A primary user of a D'Marie account can also add sub-users (other office members, managers, interns, etc.) if desired. Often the designer or stylists themselves does not handle the garment request process and instead has an assistant cover the task. By adding more than one user per account, the lead of the account can designate tasks to be completed by others yet still be able to monitor progress because notifications are seen by all users on the account.

Permissions

When inviting other users to an account, the primary user is able to allow or restrict various capabilities for the new invitee. This enables the primary user to control who can and cannot be contacted by outside networks, as well as who can manage collections, projects, garment requests, etc. By letting the primary user enact these permissions, D'Marie's system eliminates possible errors or confusion that could stem from an unauthorized user completing a task they shouldn't.

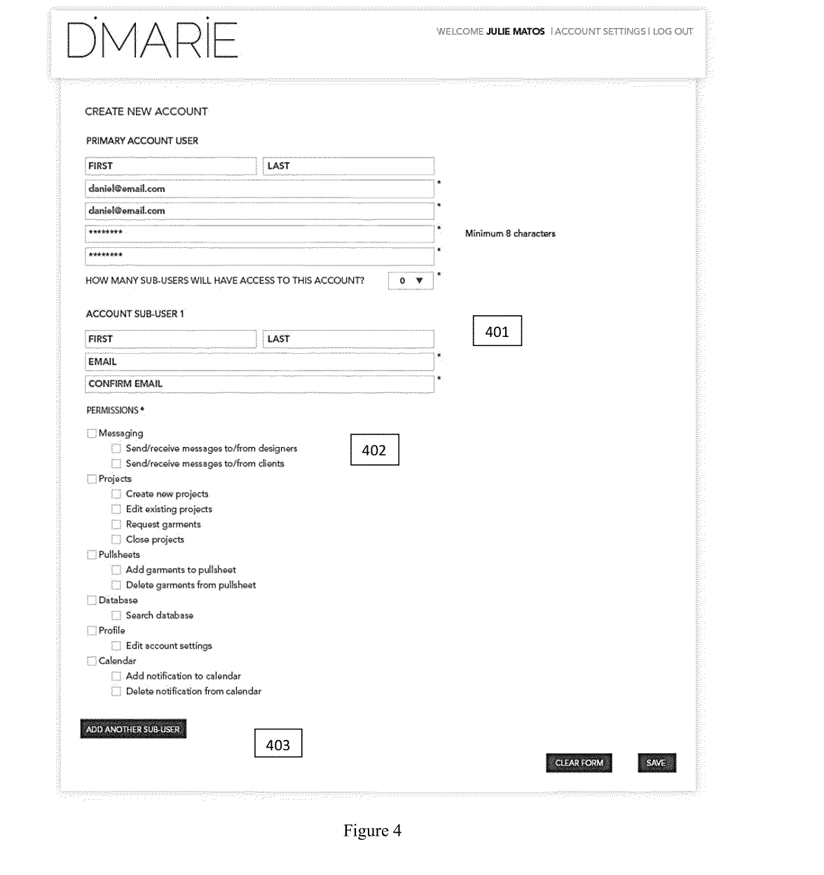

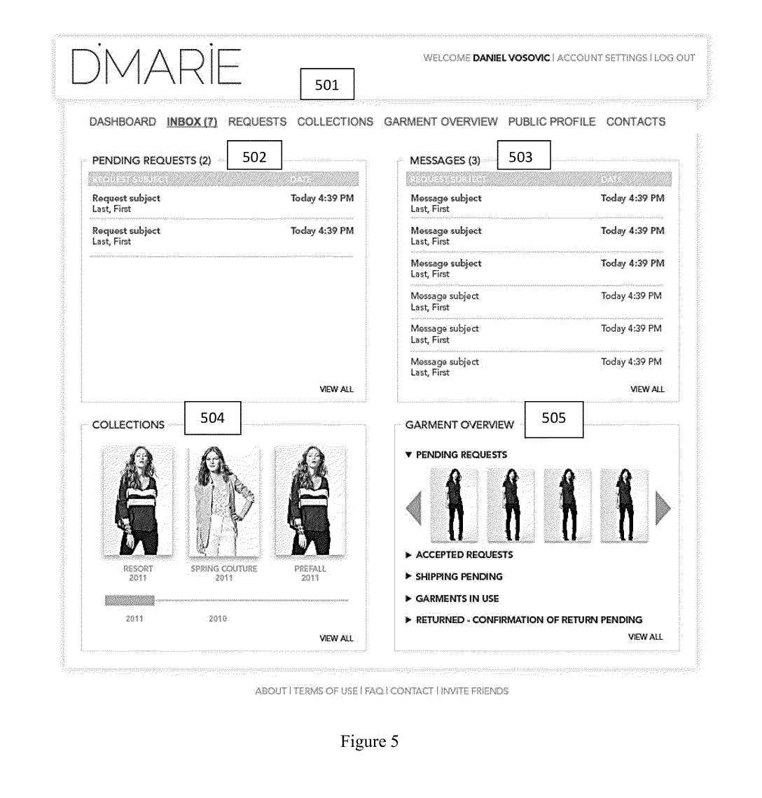

FIG. 4 is an exemplary embodiement of the ability of a primary account user to limit the sub-users' permissions on their primary account. The primary account user enters the sub-user's information into the requested fields (401) and the chooses which permissions to either enable or disable (402), in order to limit the sub-user's access and abilities within the profile. A primary user can choose to add another sub-user to the account (403), in which case they enter a separate set of permissions for each subsequent sub-user. The permissions can be changed at any time and revised should a sub-user leave the company or incur new responsibilities.

Calendar

The calendar feature is a way for industry users to both visually manage their time as well as automatically be kept up to date on each garment and project's next steps in the production process. The calendar functions as a timeline displaying notifications for garment requests and generates reminders from the various actions taken by the stylists and designers so that no step of the request process is overlooked, no matter whom within the company completed the last task. Additionally, project stages are recorded in order to keep all users connected to the project on the same schedule and equipped with the same information. In addition, the calendar offer's a user the ability y to make custom notes about appointments, meetings, project deadlines and share those among the company and their network.

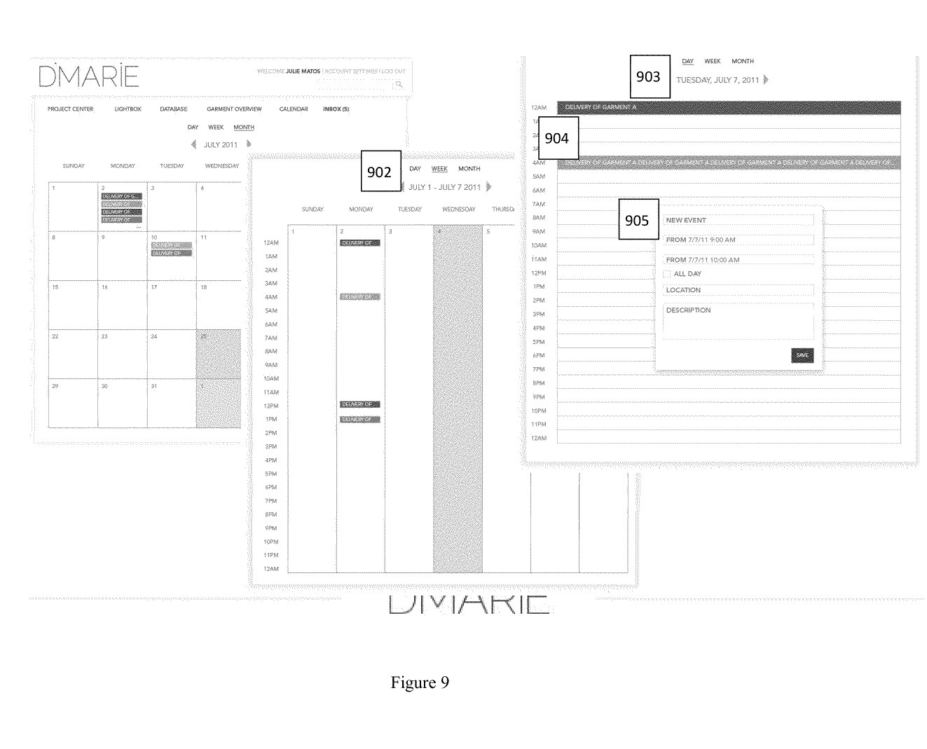

FIG. 9 is an exemplary embodiment of the calendar system on the D'Marie platform. This calendar can be used to visually display several dates associated with garment profiles, projects, and custom deadlines. A user can select to view the calendar view by day, month or week. (901,902,903). Each note added to the calendar can be constructed and edited by selecting the title of the note and completing the note form (905) with a title, time, alarm, and details. Notes are displayed on the calendar according to the date and time assigned in the note form. A user can select a note title (904) to open the form and view all of the note's information.

Garment Database

This database contains all of the garment profiles uploaded by designers. It is sortable via descriptions such as collection type, designer name, garment category, and year. Only stylists have access to this database on the industry platform. In some embodiments, every garment will have a “quickview” which enables the stylist to see further details of the garment. A stylist can also message the designer, “pull” the garment, or send a request to the designer directly in the database. “Pulling” is an industry term used to describe the act of adding a garment to a pullsheet before a stylist sends a request to the designer.

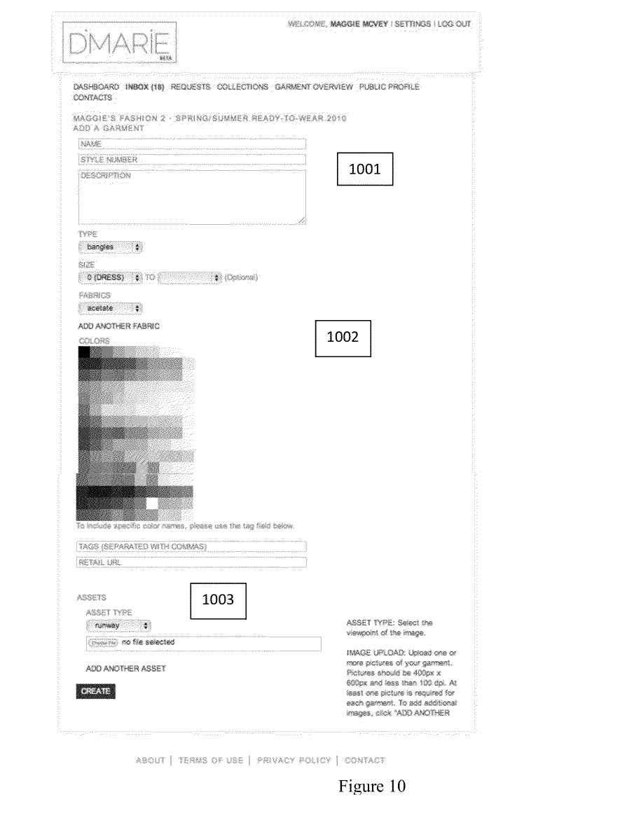

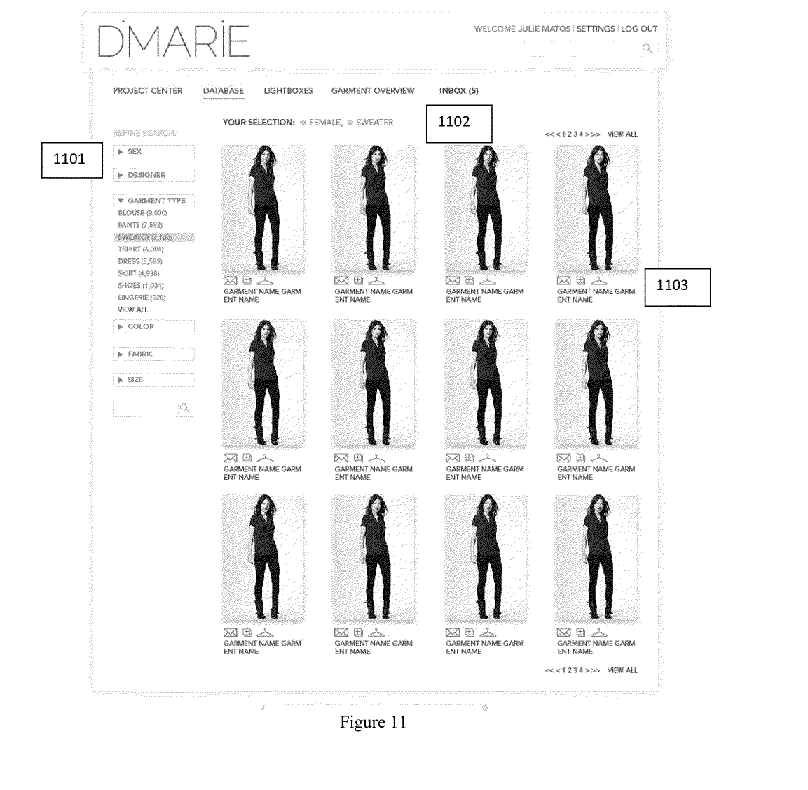

FIG. 10 is an exemplary embodiment of the ‘Creating a Garment Profile’ form, which allows designers to upload individual garments into a collection by filling out a form that enables them to provide garment specificities and store in the garment database. (1001) The designer account enters information about the garment into the form so that it will be properly searchable in the industry and public database. Users are able to identify garments by name, style number, type, sizes, fabric, tags, colors and photo. (1002) Colors are chosen to be associated with the garment. The user can select unlimited colors to save in the garment profile. The user can then enter any tag into the form that is associated with the garment, which will make it easily searchable on the database. The retail URL can also be entered into the form, which when clicked on the garment page will open a new window by which a consumer can purchase the garment. Users are able to upload a photo (1003) of their garment by browsing through saved images on their personal computer. The system also gives them an ability to associate an asset type with the photo, which indicates the viewpoint of the photo selected.

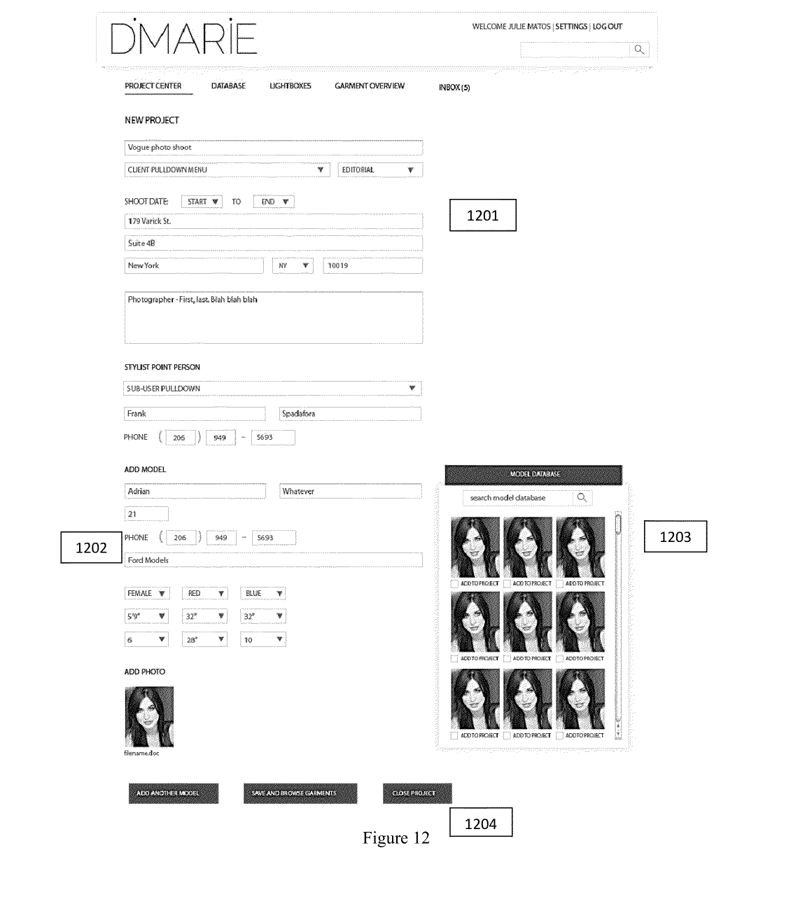

FIG. 11 is an exemplary embodiment of the Garment Database available on the industry server of the D'Marie website. This database contains all of the completed garment profiles (1102) uploaded by designer users. Each garment profile is paired with a set of icon buttons (1103) that enable a user to complete an action for that specific garment profile. A user can add a garment profile to their master pullsheet, send a request, or message the designer of the garment directly from within the industry garment database. A user can sort garment profiles within the database by using the search tools (1101) that allow a user to search by designer name, garment type, color, size, fabric, collection type, collection year, and other tags that are uploaded per garment profile.

New Project Form

A New Project Form is completed by a stylist for each new production. It includes fields for the project title, client name, project category, shoot dates, shoot location, other details (such as photographer, production notes, etc.), and the point person for the stylist (for example, an assistant), along with a model database section.

FIG. 12 is an exemplary embodiment the New Project Form. A Stylist completes this form at the beginning of a new project, listing project details and tagging other people that will be involved with the project (point person, models, clients, etc.). Stylists give the project a name and provide an address by which the project will take place. They will also list the photographer(s) and stylist point people (sub-users) working on the project. (1201) The user enters into the form information about the models they plan to use for the project, including name, contact information, physical specs and a photo. (1202) The model database (1203) can be used to find the exact model in their project. By selecting on a model from the model database, their shared information (photo, first and last name) will automatically be filled into the form. For a stylist that has used a particular model profile with a past project, the rest of the model's stored information and any personal notes will automatically be filled into the form as well. At this section of the form (1204) the project form can move to the next step by adding another model, saving and browsing garments, or closing the project and moving to the approval process.

The model database is a feature which ensures the models get credit for each project they are in, as well as makes it easier for the stylist to keep track of the information for each model. In the overall database only a model's first and last name along with a photo is kept on record. However, once a stylist has used a model, all of their information is saved in the stylist's private model database so they can edit previously entered measurements, additional photographs and angles, or their contact information.

The model database can be accessed only through the New Project Page. Once the model's name begins to be entered by the stylist they will pop up and the stylist can choose the correct model (if there are multiple models with the same name, the headshot will be used). Their basic information will pop up automatically; if they have been used before by the stylist all of their information will be filled in, including measurements. If they have not previously worked on a project with the particular stylist their measurements, additional photos, and contact information will need to be entered.

Once the New Project Form has been completed, a master pullsheet is created for the project the client will be notified that they have been associated with the project. Once the client verifies that they did commission the stylist for the project the stylist will be able to begin pulling garments that they would like to use for the shoot.

Master Pullsheet

When a stylist creates a project, a “master pullsheet” is automatically generated for the project. This pullsheet hosts all of the garment profiles the Stylist would like to use for the project. A stylist can “pull” the garments of designers who are in their network from the database and put them into a project's pullsheet. However, they cannot send garment requests to designers for the project until the company has accepted the network connection from the stylist. This connection is detailed on the project form when the stylist is required to list the “client”.

The title of the project and the assigned project category appear at the top of the master pullsheet along with a search bar for the stylist to search for garment profiles within the selected pullsheet. Within the master pullsheet, the stylist can see thumbnails of all the garments that have been pulled. Under the thumbnail of a garment profile the stylist can see the designer name and the style number of the garment as well as the current status of the garment. If there are more garments than allowed in the window, a scroll bar will appear for the user to scroll down the window. A stylist user is able to hoover over the thumbnail to see a “quick view” of the garment. This information includes the garments: title, style number, designer name, color, fabric, size, details, tags, history, and the icons (hanger, envelope, check box). In addition, there are icons that indicate the action options for the user per garment profile: Clothing hanger (request garment), Envelope (to message the designer of garment), Check Box (a user can click a checkbox to link multiple garments to one action).

Actions are also listed at the bottom of the pullsheet window. A stylist can “Remove Garment,” “Add to Custom Pullsheet,” “Create Custom Pullsheet” (a pop up window appears and asks the user to complete the details of the custom pullsheet), “Message PDF” (a pdf of the pullsheet is generated and the user is directed to a “compose message” in their inbox), “Delete Pullsheet,” and “Print PDF” (a pdf is generated and the user can print to with the document).

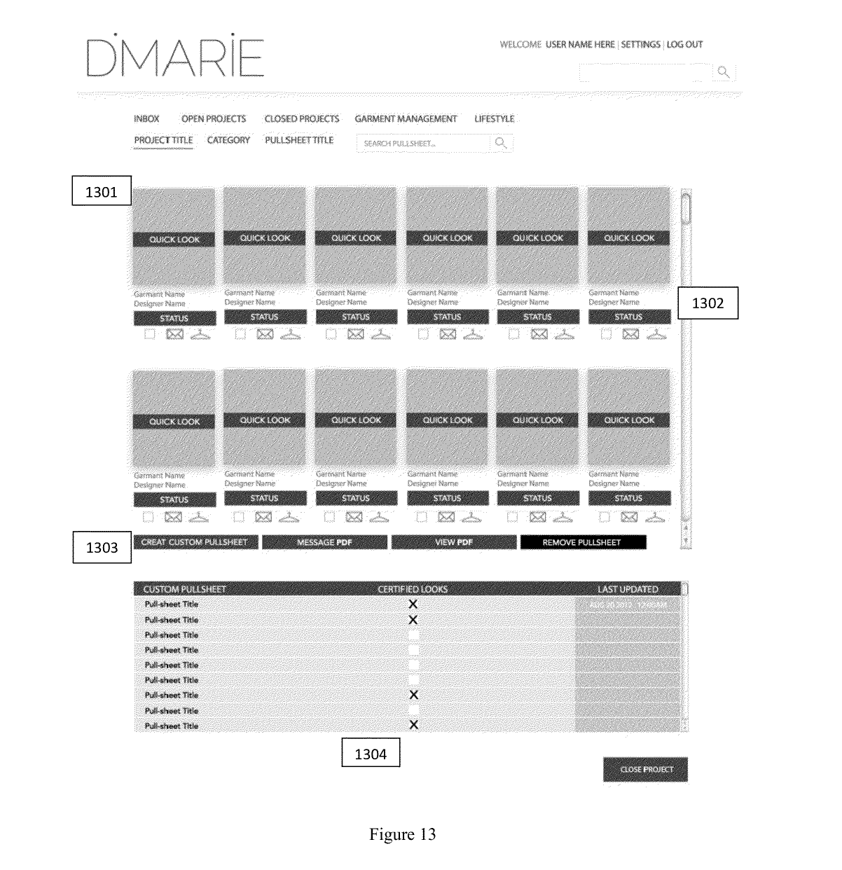

FIG. 13 is an exemplary embodiment of D'Marie's Master Pullsheet system. Each project that is opened by a user is assigned a Master Pullsheet. This is an evolving form that enables a user to create, sort, store, and close custom pullsheets with garment profiles per project. In the main Master Pullsheet frame (1301), the garment thumbnails that have been pulled or requested for the project appear in rows according to the garment's status. A user can work directly within a master pullsheet to complete actions like requesting, messaging a garment's designer, returning garments, and adding a garment to a pullsheet by clicking various icons next to the garment thumbnail (1302). A user also creates custom pullsheets, views PDF documents of the pullsheet, messages the PDF document, and closes pullsheets within the Master Pullsheet by clicking various buttons below the main frame (1303). Custom pullsheets that have been created for each project are stored within the Master Pullsheet in an inbox that appears below the main frame (1304). When a user selects the title of a custom pullsheet, the garments within that specific pullsheet are generated and displayed within the main frame.

Custom Pullsheet

Within a master pullsheet a user can create “custom pullsheets”. Custom pullsheets are used to group a collection of garments profiles. There are two types of custom pullsheets: “Certified Project Looks” and “Regular Custom Pullsheets”. When a custom pullsheet is created the garment profile is duplicated and the original profile remains hosted in the master pullsheet.

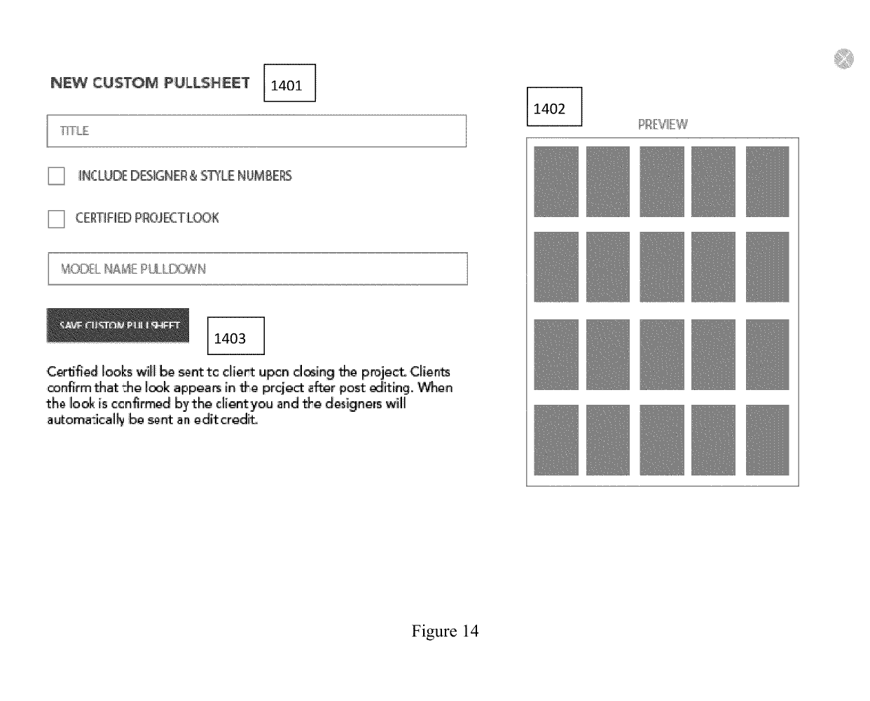

FIG. 14 is an exemplary embodiment of the Custom Pullsheet form and process. This is the form completed by a stylist in order to categorize a group of garment profiles in a specific project. A user is able to enter a title (1401) for the pullsheet that is specific to the project and description of selected garment profiles. Thumbnail images of the garment profiles that have been selected for a pullsheet appear in the preview frame (1402). In addition, a user can select a model profile from the model database to include in the pullsheet and tag the pullsheet as a “certified” pullsheet. A user can save pullsheets to the pullsheet database by clicking “save custom pullsheet” button (1403).

The list of custom pullsheets will include the title of the pullsheet, an asterisk (indicating the custom pullsheet is a “certified project look”) and the date and time that the garment was last updated. The list of custom pullsheets can be sorted by pullsheet type and most recent date.

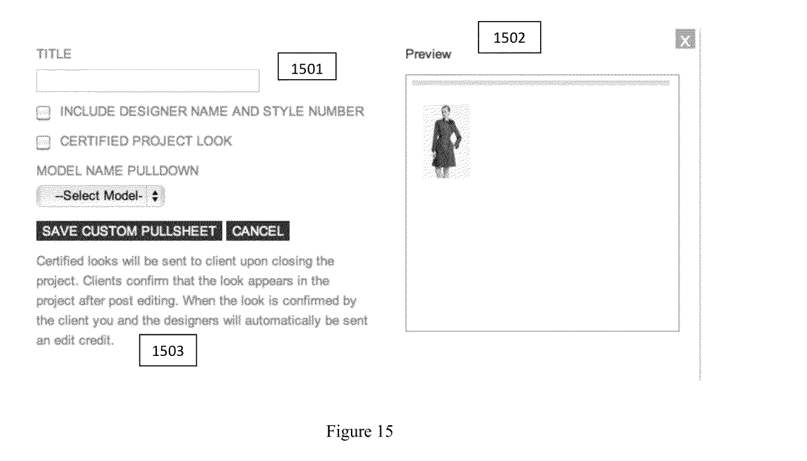

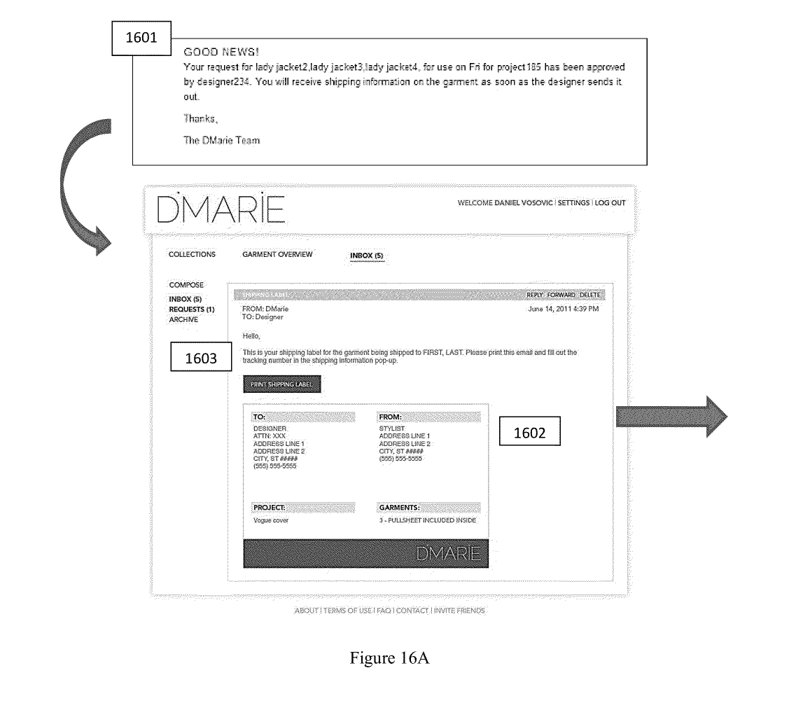

FIG. 15 is an exemplary embodiment of the “Certified Look” custom pullsheet form and process. When a stylist user has completed a project, they are required to close each look by identifying which pullsheets are “certified looks”. To create a certified custom pullsheet a user selects garment profiles within the master pullsheet and click “close look” button. Thumbnails of all of the garments that have been selected will appear in the “preview” frame (1502) of this form. Certified looks are attached to the Final Production form that is sent to the client which is generated after the stylist closes a project. A user can verify all of the information associated with that look (designer name, garment style numbers, models, and look title) (1501).

Certified Project looks are custom pullsheets that indicate a specific photo or scene within a project. When a project is completed all of the garments within the certified look can be verified before the stylist can add the certified look custom pullsheet to the Final Production Form which is sent to the client of the project.

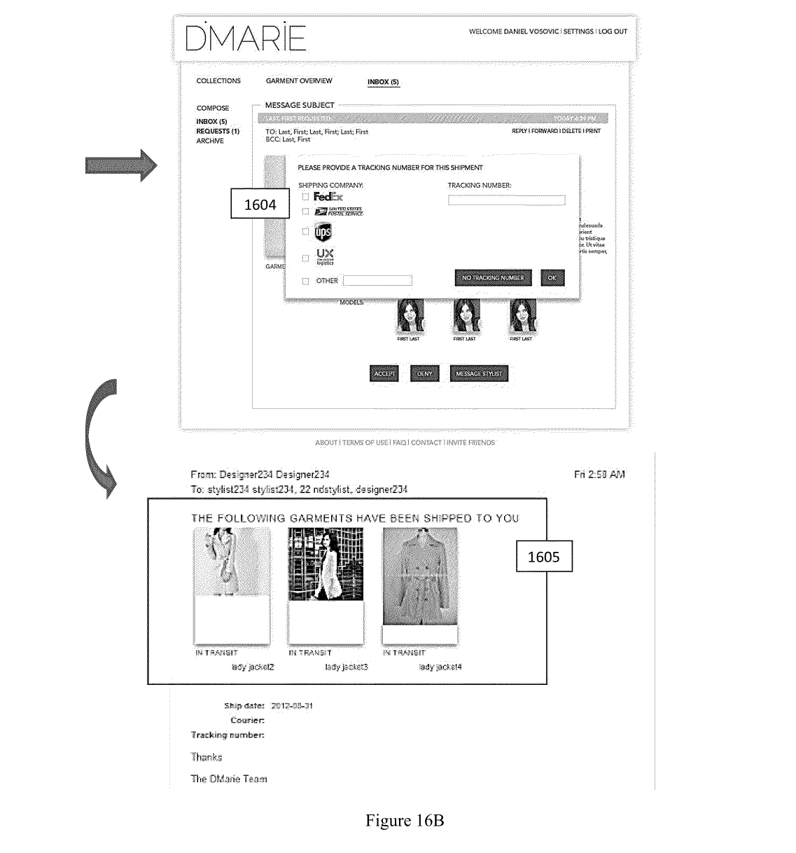

FIGS. 16A-B are an exemplary embodiment of the Shipping Process and Approved Request Messaging System between designer (User A) and stylist (User B) user profiles. The series of forms and automatically generated messages assist both users in creating and recording shipping information per approved request. When User A approves a garment request, User B will receive a message in their inbox letting them know the garment has been approved (1601). Next, a shipping label is automatically generated by D'Marie's messaging system with a combination of information from the New Project Form and User Profile databases to display the address of the person who is shipping the package (user A), the number of garments included in the package, the project the garments were requested for, and the address of the person who should be receiving the shipment (User B) (1602). This shipping label is sent to a user's inbox from D'Marie's messaging system (1603). After reviewing and approving the information the User A is prompted to enter the 3^{rd} party tracking numbers from exterior shipping companies into the shipping form and submit by clicking “no tracking numbers”/“ok” buttons (1604). After User A completes the shipping form, User B is sent a notification message including all information provided by User A in the shipping forms (1605). This exact process is replicated when User B sends the garment back to User A, but User B is then completing the forms and User A is receiving the notification messages. Therefore, the shipping process is as follows:

1. A stylist requests the garment(s)
The request is approved or denied

2. If the designer receives the request message and accepts
A message is sent to the stylist to let them know the request was accepted
The shipping label & pullsheet appear for designer in the request message

3. A tracking number is assigned and entered
Message notification is sent to recipient of shipment for the tracking number

4. Designer prints shipping label and pullsheet
Garment Status is updated to “in transit”

5. Stylist receives garment
Garment status changes to “received”

Shipping label details include:
TO: Profile name who sent request (profile address)
ATTN: Recipient's Name
FROM: Person who is shipping garments (profile address)
PROJECT TITLE
NUMBER OF ITEMS IN SHIPMENT
D'MARIE LOGO (placed at the bottom of the label)

Included with the shipped package is a pullsheet with:
From: (Shipper's name)
Attn: (Stylist Name)
Project title (top of document)
Garment thumbnails, Style Numbers, and Garment Names

Request Process

The Request Process is the function for stylists to requests garments for use from designers. Each request can be for one or multiple garments. The stylist clicks “Request” on a garment profile. This can happen in a pullsheet or directly in the industry database. If they send a request for a garment directly from the database, a pop-up asks them to select a project to associate the request with.

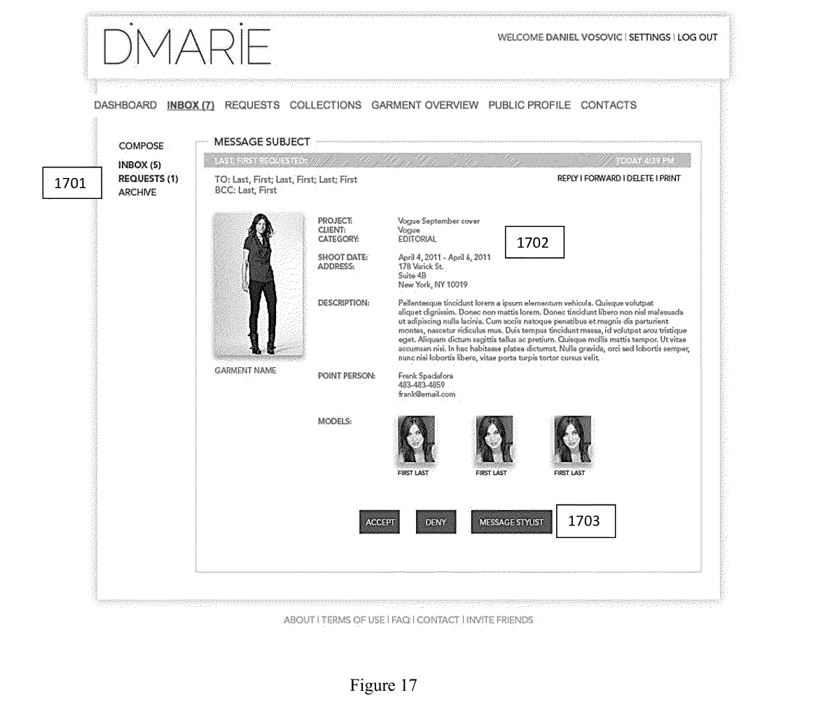

FIG. 17 is an exemplary embodiment of a Garment Request message that is received in the designer inbox when a stylist would like to use a designer's garment for a project. After opening the request message, the user is able to view the sections of their message inbox (1701) and has the full functions of their request/message inbox system. The Garment Request message (1702) displays all of the details of the project as provided by the stylist in a New Project Form. The designer can then choose to reply to, forward, delete, or print the request. The designer has the ability to accept, deny or message the stylist, based on the content of the request (1703). Regardless of the button chosen, a message is generated and sent to the stylist to inform them of the designer's decision.

A request message will be generated after clicking “Request,” but first the stylist needs to confirm the project information in a pop-up that shows the project's info, including: Project Title, Client, Project Category, Shoot Date, Location, Details, Stylist Point Person, Models, thumbnails of the garment(s) being requested & their style number. Optional: Attach Letter of Liability (A Stylist may want to attach a PDF/.doc document called a “Letter of Liability,” a document generated outside of the system. It is not required).

Additional “Pull Dates” feature: This allows a stylist to detail a time frame (mm/dd to mm/dd) that is different than the shoot date that they would like the garment for, which lets the designer know the exact amount of time the stylist expects to have the garments.

Once they click “Send Request,” the pop-up closes and the message is sent to the designer's request inbox. Stylists will get a follow-up message in their inbox letting them know if the request was accepted or denied by the designer.

Messaging

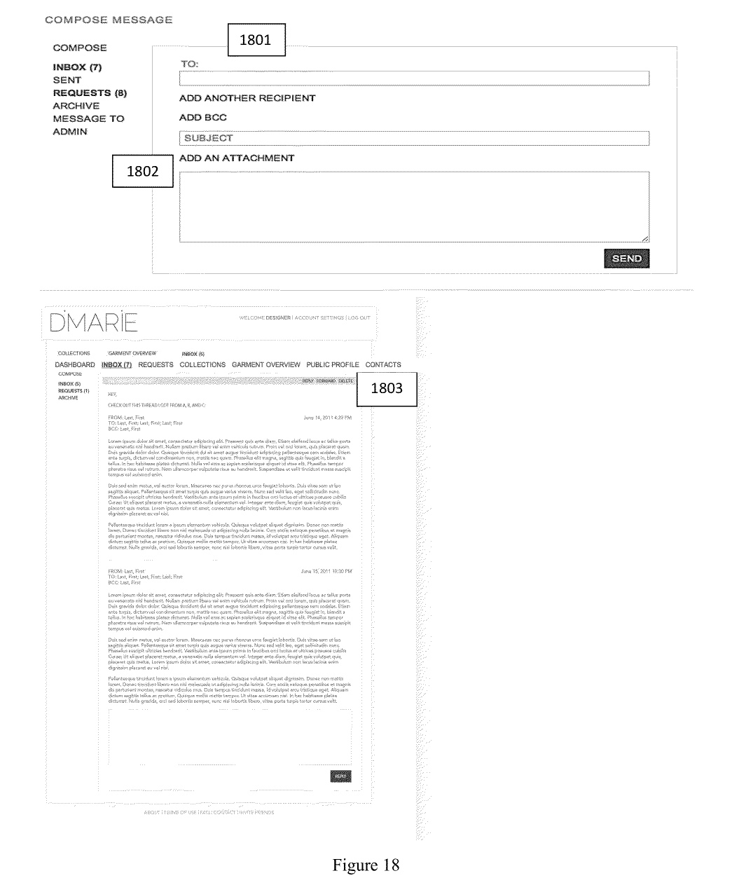

FIG. 18 is an exemplary embodiment of the D'Marie Messaging System, which enables industry users to send and receive messages from sub-users and other accounts in the network that have an industry profile. The message recipient's name is entered into a field (1801); the user can choose to message a single user or add more than one recipient by clicking the “add another recipient” button. The user can add attachments to the message (1802), with the ability to upload documents from their local server. Messages are displayed in threads (1803), which display all correspondence between users.

D'Marie allows for a messaging system similar to email. As with email, users will be able to compose a message, reply to a message, reply to everyone on a thread, attach files, see an inbox, and see read/unread messages in the inbox. In some embodiments, D'Marie includes an email system and a message system. For example, D'Marie can send emails to personal email accounts (e.g., a personal email account for a stylist) during the sign-up process, for promotion reasons, to alert a user of certain notifications, and/or for other notifications. Messages, in contrast, are not sent to personal email accounts, but instead can be sent across profile types (e.g., designers, stylists, etc.) and managed in messaging inboxes associated with each profile type. The messages (e.g., garment requests, network requests, custom composed messages, shipping notifications, etc.) can be allowed and/or restricted based on, for example, the industry profile's network system, unique profile preferences, or both.

A user can: send and receive messages to and from others (individuals or multiple individuals) within their group (company); send and receive messages to and from others (individuals or multiple individuals) whom are in the user's network; see threads, where multiple replies to a message results in a viewable history of the messages.

A stylist is able to send garment requests via the messaging system with details of the request, appropriate interactions based off the workflow status, and the ability to send messages to and from those involved in the request to work out details that go beyond the ability of the site. Requests are special messages that go to a group (company) and not just an individual.

Another request sent through messages is a network request. This can be triggered by a garment request where there has been no previous interaction.

Similar capabilities for the project workflow will rely on messaging as with the garment request workflow.

Networking Connections

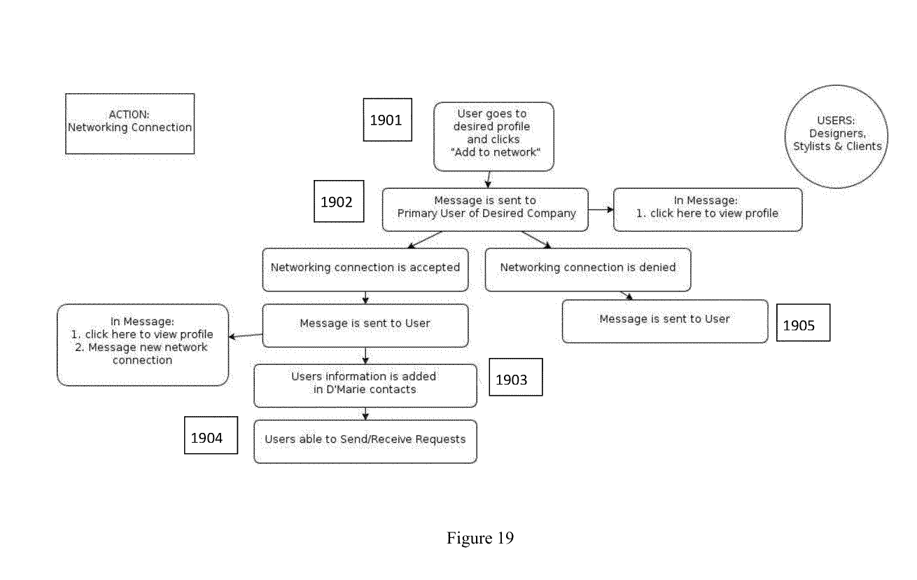

FIG. 19 is an exemplary embodiment of the industry platform network connections system between two company profiles. User A can join User B's network, which enables them to share various garment and project profiles as well as send garment and project requests to mutually share information on the industry profile. Network connections on the industry platform are a security feature that ensures one user cannot act on behalf of another user without first getting permission (1904). A request to be added to a user's network can be made by clicking the “Add to Network” button on any industry user profile (1901) or when prompted while completing a system that requires network connections to be made before moving forward (i.e. new project form, sending garment requests). User B receives a message notification (1902) that User A would like to join their network. After User A accepts User B, the contact information from User B's profile is added to User A's contact database (1903).

Networking connections are made between companies, not individual users within a company. For example, a networking connection request would be sent to Calvin Klein as a company, not Calvin Klein the individual, and then the Calvin Klein account will accommodate multiple users who will all operate under the brand name.

Connections allow various user types to execute certain actions with other brands and individuals at those brands. The actions a user can take are determined by the permissions given to them by the primary user on their brand's account. Every user with permission can manage network connections on the Network Address Book page of their brand's industry profile.

A section of the Network Address Book page allows an existing industry user to search D'Marie's entire database of users from all three profile types on the industry platform (designers, stylists, companies). They can narrow the search in this section by user type or use a free form search bar to enter a company's name. When they find a company they would like to connect networks with, they click “Add to network.”

There are several places on the industry platform that designers, stylists, and companies can click on the “add to network” button: a company's industry platform profile, when a stylist is trying to send a request to a designer they have not yet connected with (a message will pop-up that includes the “add to network” button), and when a stylist is completing a project form and they are not already connected to the designer (a message will appear that reads “You are not a member of this user's network. Please send a request to join their network”).

When a networking connection is made it allows several things to happen for each profile type. When a stylist connects with a company they can tag the company as a client in a future project form and send messages to members of the company.

When a company is tagged in a project profile, which is created by the stylist, that project is placed in the company's “Open Project” database, which can be accessed via their dashboard. When a stylist connects with a designer they can send requests and messages to members of the designer company, and vice versa.

Address Book Page

The address book is the database of information that is generated when a “network connection” is made between a designer, stylist or client profile on the industry platform. The address book contains the following for each brand in the user's network: Brand type, logo, name, phone number, fax number, employee list, profile name, website, and address. After the networking connection has been made, the members of that brand's profile will be automatically generated when a user is sending a message. For example, if a stylist is sending a message to Danny West at Calvin Klein and they type “D,” Danny's name will appear as “Danny West—Calvin Klein.” Should the Stylist type “C,” Danny's name will still appear because the company he works for, Calvin Klein, starts with a “C.” Additional actions on the address book page include toolbars for “Search My Network” and “Search Full D'Marie Network,” as well as options to remove a contact or message an individual employee of a company.

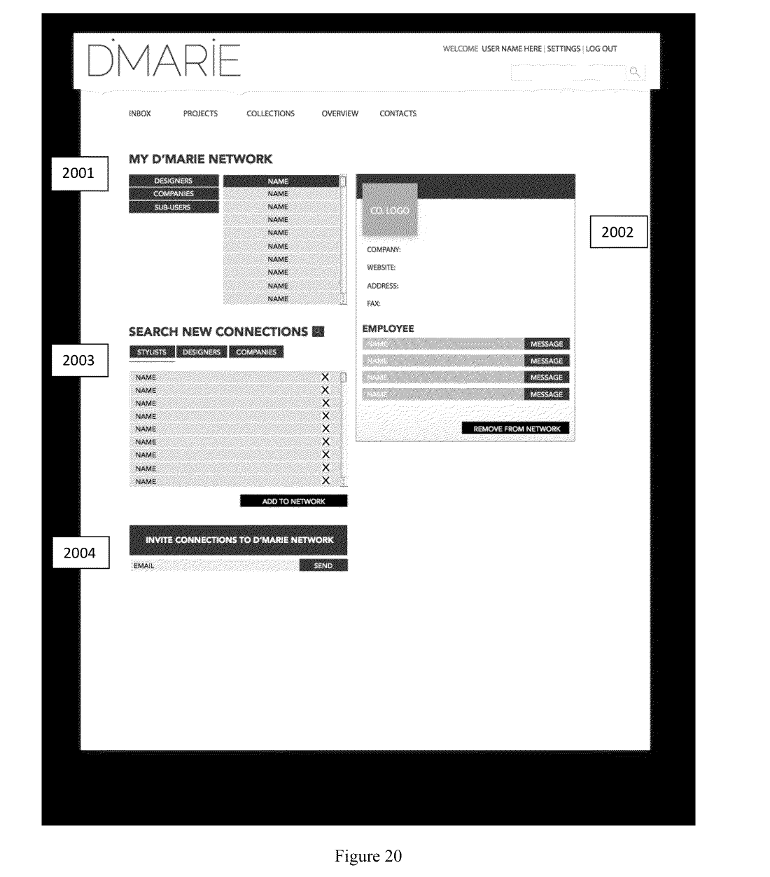

FIG. 20 is an exemplary embodiment of the Contact Page/Address Book. Another function of this page is to find new connections, invite people to use the D'Marie platform, and message their sub-user employees. Users can search for existing user profiles in their D'Marie network based on various categories (2001). The user category that is highlighted on the left determines the contacts that appear on the right. When a specific user profile is selected in (2001), the personal contact information submitted by that contact appears in the window labeled (2002). Users are able to identify and message employees within the selected company profile and review the general company contact information. Users can search for new connections via the user profile database based on user category type (2003). As search results appear, users can choose to add a connection to their network by selecting the “Add to network” button. Users can invite new users to the D'Marie Network by entering an email address into the free-form field (2004). An invitation email is generated and sent to the email address provided in the form.

Statuses

Every garment profile that is entered by a designer in the database has a status. This status tells the designer and stylist users where the garment is in the “garment request cycle” and lets them know the next action needed to complete the entire cycle. When a user completes an action within the garment request cycle the status will automatically change in the designer and stylist profiles as well as in the industry database, all at the same time. There can be up to three statuses displayed for one garment profile at one time. These statuses are not viewable to the public on the consumer website. Statuses are not manually changed. They are only automatically changed when an action has been executed.

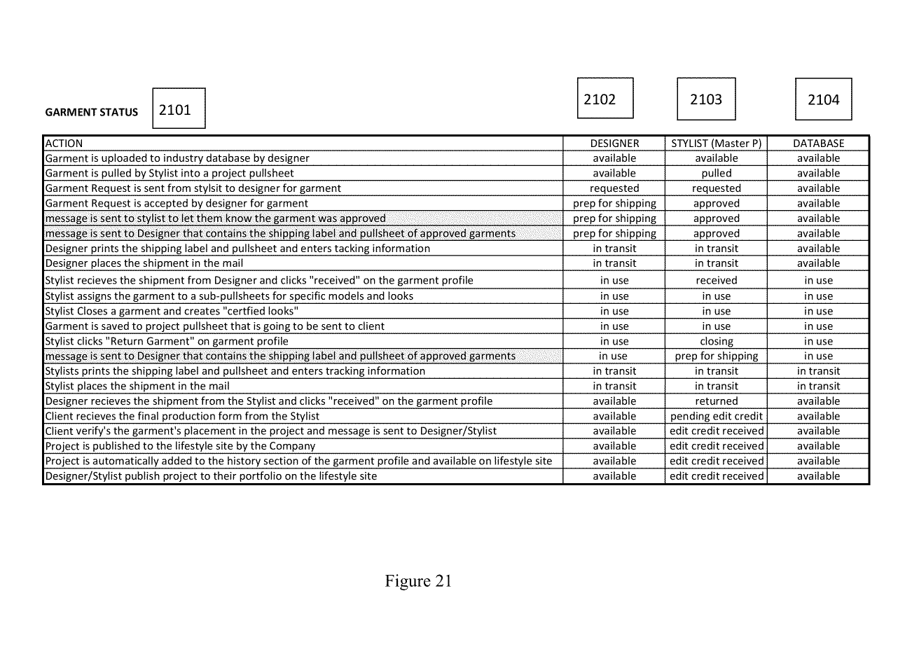

FIG. 21 is an exemplary embodiment of the garment profile status system. One garment profile can have multiple statuses at one time, but only displays one status depending on which user profile the garment profile is being viewed by. The status changes as a garment profile moves through the request, shipping, and project verification systems (2101). Designers are able to see the location and availability of their garment profiles (2102). Stylists view a status of the garment profile that has been pulled according to its existing stage on both the request & messaging system (2013). Simultaneously, stylists who are looking at the garment profile within the garment database on the industry platform see a modified version of the garment profile status (2104).

When a garment is first entered into the database by a designer the status it receives is “Available”. This is the first stage of the garment request cycle and it means that the garment is not currently in use for a project and available to be “pulled” from a designer by a stylist for a project. FIG. 21 shows the user actions and correlated statuses as seen by designers, stylists, and in the garment database.

Garment Management Section

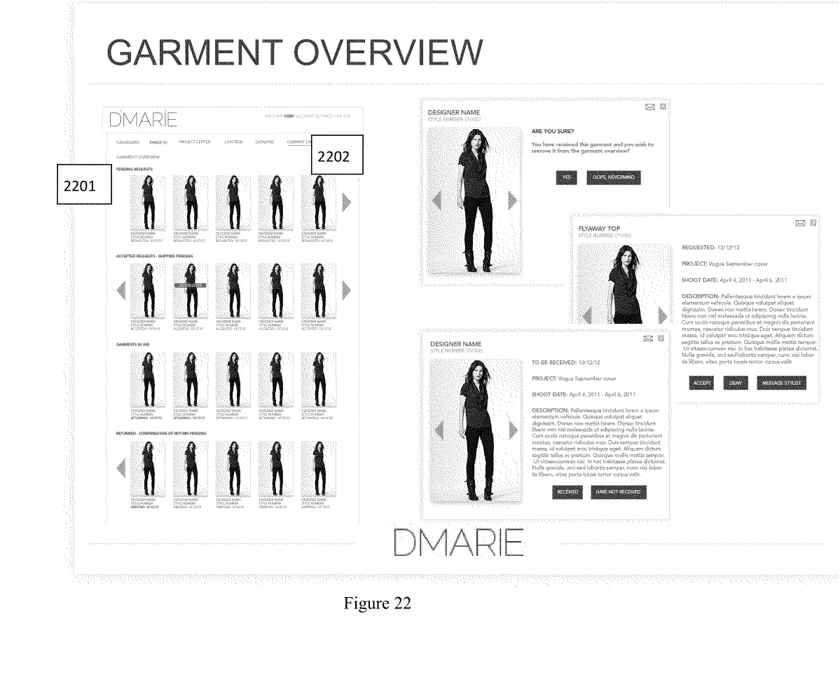

FIG. 22 is an exemplary embodiment of the Garment Management Overview section of designer and stylist profiles. This section displays all garment profiles that the user has interacted with or uploaded according to the status of the garment profile. (2201) The garment profiles are listed in order of time sensitivity. A user can click on any garment profile to execute an action that will move the garment along to its next stage in a various system (2202).

This function displays all garments in a project according to their statuses and lets the industry user act upon the item, depending on the status. No status can be changed manually; they are generated automatically by the various actions in the queue.

Open Projects Inbox

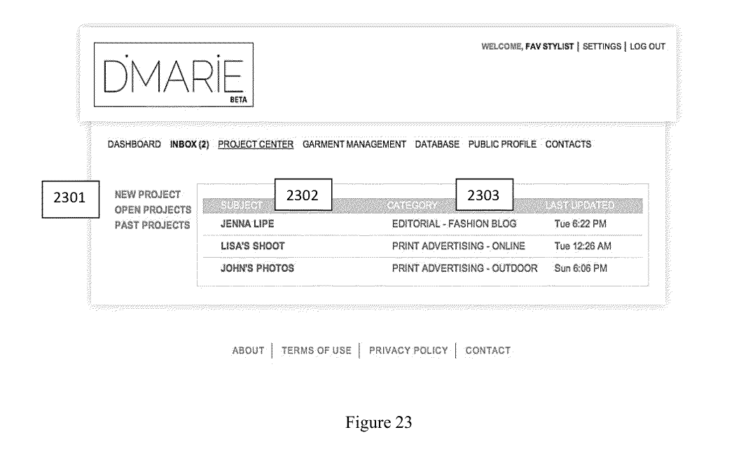

FIG. 23 is an exemplary embodiment of a Project Center inbox database for a user to manage all of the projects that they are involved with. Users can toggle through specific project database section (new projects, open projects, and past projects) (2301). The subject component (2302) lists the names of the projects as entered into the New Project Form. The category component indicates what type of project it is and when it was last updated (2303). The newest project in the database appears at the top of the inbox.

This section can be a main component of the industry platform's dashboard. It can allow stylists, designers, and clients to organize and keep track of their open projects, their status, and what steps still need to be taken in order to complete the process.

Closed Projects

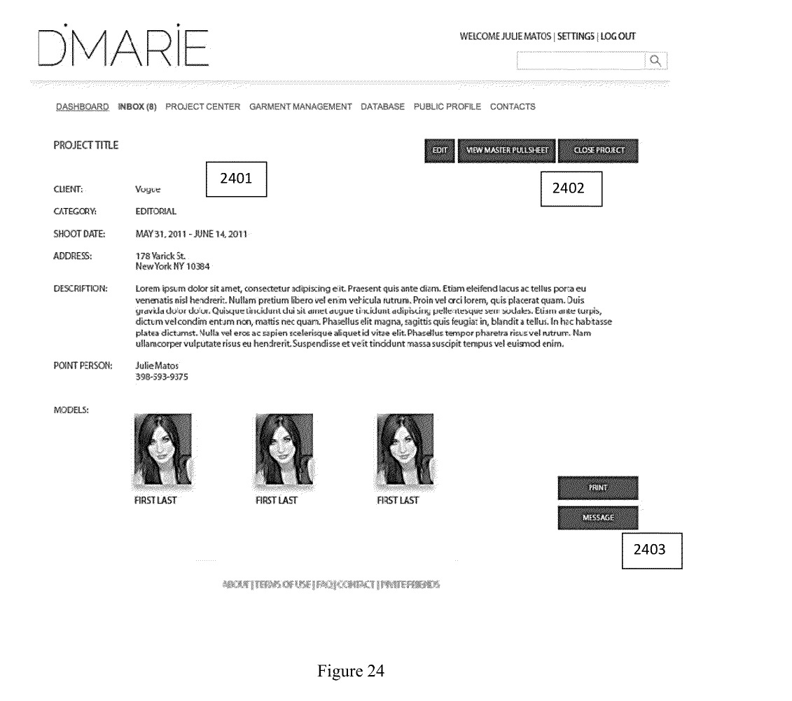

FIG. 24 is an exemplary embodiment of an Open Project page that is a source for stylists to refer back to in terms of their current projects. The Open Project display (2401) shows all of the information entered into the New Project Form including the approved client, project title, date, location, a description of the project, and photos of the model(s). The user has the ability to edit the current project or open the master pullsheet (2402) if there are any changes that need to be made. They can also close the project when their task is finished by clicking on the buttons “edit”, “view master pullsheet,” or “close project”. The stylist can print a PDF of the project page or message a PDF of the project info by clicking “print”/message” (2403).

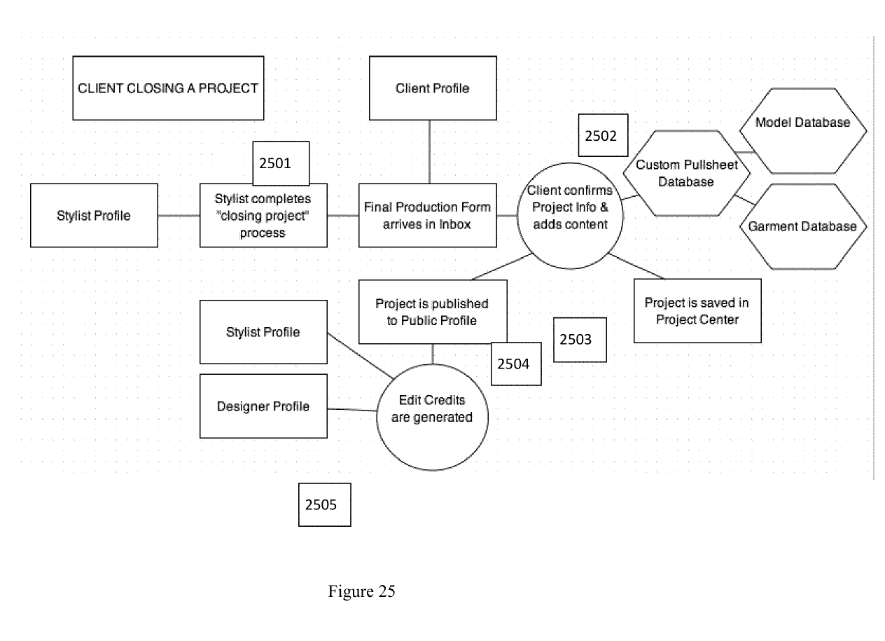

FIG. 25 is an exemplary embodiment of closing a project in the D'Marie platform. A client closes a project via the Final Production Form that is generated by the messaging system and sent to them after a stylist closes the project from their profile. The Final Production Form is sent to a company's inbox (2501). The Final Production Form contains information entered by the stylist in a New Project Form and pullsheets of all the certified looks, which contain garment and model profiles (2502). Company profile users add information by clicking “Add Final Project Video or Photos.” When a project is closed, the information is stored in the public archive of closed projects and also in the user's project center under “Closed Project” (2503). A company can also promote the project on their own public page by clicking the “Publish” button on a Final Production Form (2504). When a company publishes the project to their profile, the stylist who worked on the project and the designers whose garments were used will receive an edit credit message to their inbox with the ability to publish the project to their own public pages (2505).

Projects are closed first by the stylist and then by the client. Once closed, they will show up in the Closed Project Inbox on the user's dashboard, where they will be able to manage the project's post production actions.

Stylist Actions: To close, the stylist clicks on the “close project” button that appears on the open project view. They are taken to the Master Pullsheet that appears exactly the same but with additional buttons at the bottom of the page that allow them to close each certified look by accounting for every garment included in those custom pullsheets. In some embodiments, a project cannot be closed until all certified looks have been closed, and it must have at least one certified look to be closable.

Stylists start by selecting an existing certified look or can create a new one if the project does not already have certified looks for each model and scene. When a certified look is selected, the thumbnails of all the garments in the existing custom pullsheet appear in the window (just as the exiting master pullsheet appears). If no models were attached to the certified look when it was created, a pre-completed “Create Custom Pullsheet” pop-up will appear with all of the previously entered information for the certified look (i.e. title, models). Additional buttons include: Garment was used, Garment was not used, Remove garment from look, Close the look, and Return the garment.

When a certified look has been closed, the word “CLOSED” appears in the list of certified looks next to the “last updated” date of the pullsheet. Once all of the garments in the certified look have been accounted for they can “Close the Look.” In some embodiments, each certified look must be closed before the stylist can close the entire project. At this point the stylist clicks “Close Project.”

Client Actions: When a project is closed by a stylist, the client (brand profile) who is attached to the project will be sent a “Final Production Form” and a master pullsheet with all the certified looks. A Final Production form can be edited by a company after it is published.

A client can select multiple “project types” on one project form. For example: a company who filmed a commercial for a soft drink might also use images from the film in an online advertising campaign. The same Final Production Form can be used to archive both versions of the project.

A “preview project” button generates a preview of the project's lifestyle page. Once the client confirms that they would like to close the project and publish it to their lifestyle page, the designers will receive edit credits, stylists will be notified of the project's closure and receive credit, and the Final Production Form and Master Pullsheet are saved in the Closed Project Inbox. Additionally, FrontRow members of the designers, stylist, and brand will receive a notification in their LineUp and the client will be able to purchase advertising for the project's page.

Final Production Form

When a project is closed, the client (company) who is attached to the project will be sent a “Final Production Form” and a master pullsheet with all the certified looks. Final Production Form elements include: project title, client, project type, shoot date, address, details (suggested fields: Photographer, Producer, Hair & Make Up, Assistants . . . ), stylist, models, photos, and a project preview. It is the responsibility of the company to verify all of the information that the stylist has provided in the original project form and upload additional production photos for each certified look as it appears in the project. In addition, if it is a print based project or a short video they can upload the original project to D'Marie's server.

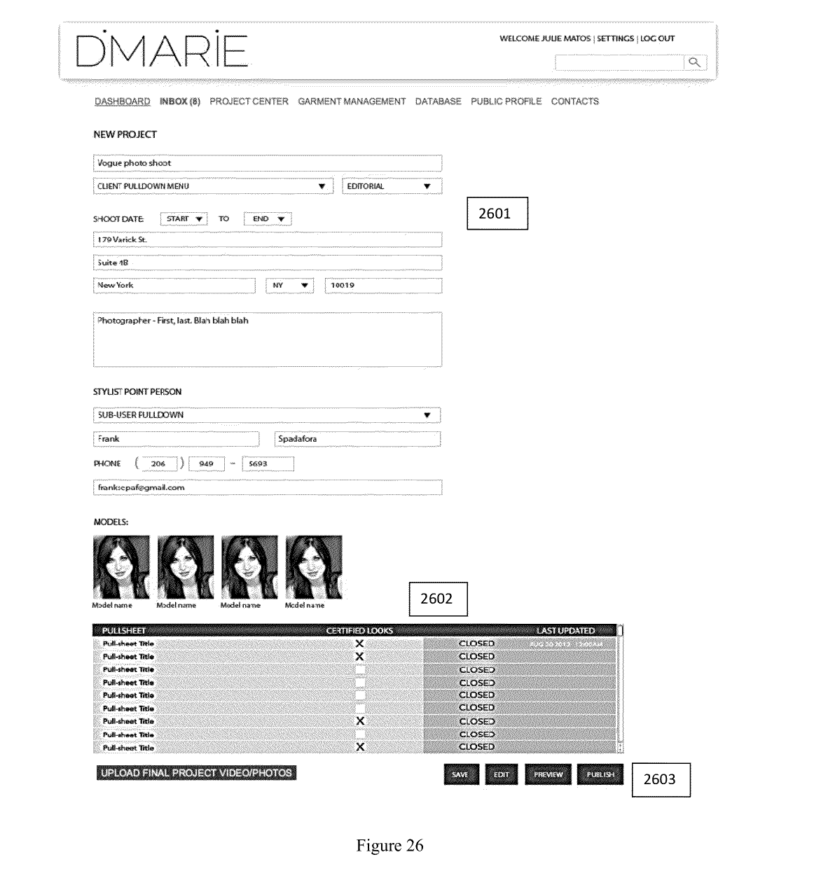

FIG. 26 an exemplary embodiment of a Final Production Form, which is utilized by a client account when a project is completed and ready to be published to the project database for consumers to view all project details. All of the information from the original New Project Form that is saved by the stylist when they closed the project from their profile is displayed (2601) and editable in the Final Production Form. Client users can go through and verify all of the certified look custom pullsheets that have been attached to the Final Production Form by the stylist (2602). Users can save, edit, preview, or publish the form by clicking the buttons (2603) and opening a PDF of the project with all of the information. Publishing allows the project to be searchable, though it will not be promoted.

When the stylist closes the project, an automatic message is sent to the company notifying them that the stylist has sent the Final Production Form and it needs to be reviewed and completed with final production photos for each look. When a final production form is completed and the project is published to the lifestyle page the project is automatically categorized in the company's “Closed Projects” section in the industry platform. A Final Production form can be edited by a company after it is published.

A Final Production Form and closed project can never be deleted from D'Marie but it can be “hidden” from a lifestyle page. When a company, designer, stylist wants to take a project off of their lifestyle page they go into the “Closed Projects” section and click “hide project” button on the Final Production Form.

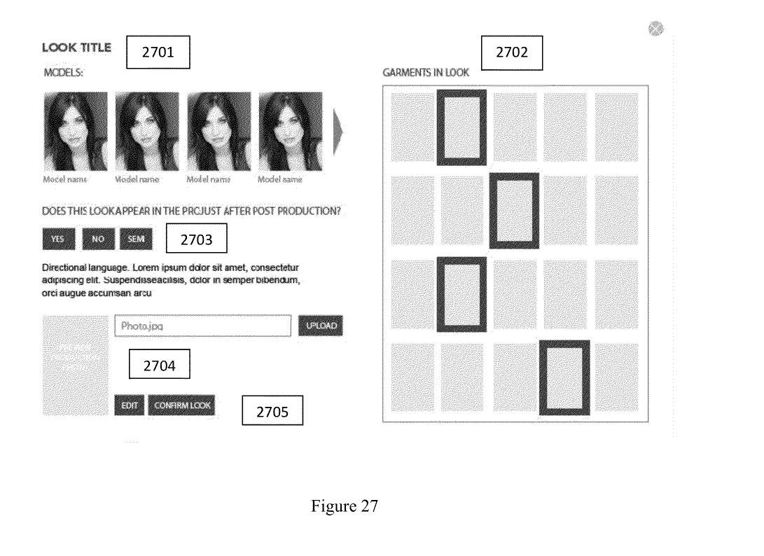

FIG. 27 is an exemplary embodiement of the process of closing a certified look custom pullsheet form within the Final Production Form. This process is conducted by the client user and is the verification process for specific “certified looks” within a project. The Look Title and model and model profiles are attached to the pullsheet by the Stylist User (2701). The client selects the correct garments featured in the look (2702) from the preview window of all garment thumbnails used in the project. The client also uses buttons (2703) to dictate whether or not the look appears in the final project so that, once published, the correct edit credits will be sent to stylsit & designer users. The client can upload a production photo of the specific look as seen in the project's final format, post editing (2704). The client confirms the look (2705) by clicking “confirm look” button.

Complete Industry Platform

In some embodiments, only designers, stylists and media producers have access to the industry profile after they agree to the terms of the system's subscription agreement. Each user type has a unique profile that has been built to encompass digital tools that assist them through the entire request process. This curated network enables each user to conduct business with only those who they have granted access to their profile via a “network request”. Designers upload their collections to the system database of garment profiles. This enables their garments to be seen by stylists and available to be used in projects for all types of brands and events. Stylists create and manage new projects once they have been commissioned by a brand, and then are responsible for using the tools of D'Marie to fulfill the New Project Forms, pull sheets, garment requests, and Final Production Forms. Throughout all of these processes, the D'Marie software system tracks each and every garment and individual included in a project, keeping a digital record that is then translated over into a database accessible by consumers. Meanwhile, the shipping and garment management tools eliminate human errors resulting from incorrect information or forgotten garments; the messaging system keeps records and provides easy communication for all involved on a project; and automatic updates for each garment keep things running smoothly.

### LIFESTYLE

The Lifestyle portion of the website grants users access to a custom profile where they can publish content about themselves and their personal style, in addition to using all of the other functions of the site (browsing collections and interviews, searching for garments and projects, etc.). This platform will let users engage with each other and have a complete experience, rather than simply come to the site to search for a garment. The Lifestyle site will act as a community by which consumers can express themselves and industry users can demonstrate their work.

### Lifestyle Features

Home Page

The Home Page will be seen by anyone coming to D'Marie. Members will be able to log in and be taken to their personal platform, and non-members will be able to click through links and search the archive. Included are the following: Toolbar (with Home, Database, Videos, News, Photos, Designers, Stylists, Log In), a Log In field, Featured Collections (a link to the section), Featured Designer (a link to designer interviews), Blog, social media icons linking to D'Marie's Twitter and Facebook, and information pages (a toolbar at bottom of page to visit About, Privacy, Policy, Advertise, contact, subscribe, employment, Terms and Services). Featured Project sections on the home page highlight one archived project from category (music, movie, television, celebrity, advertising, red carpet/event, and editorial).

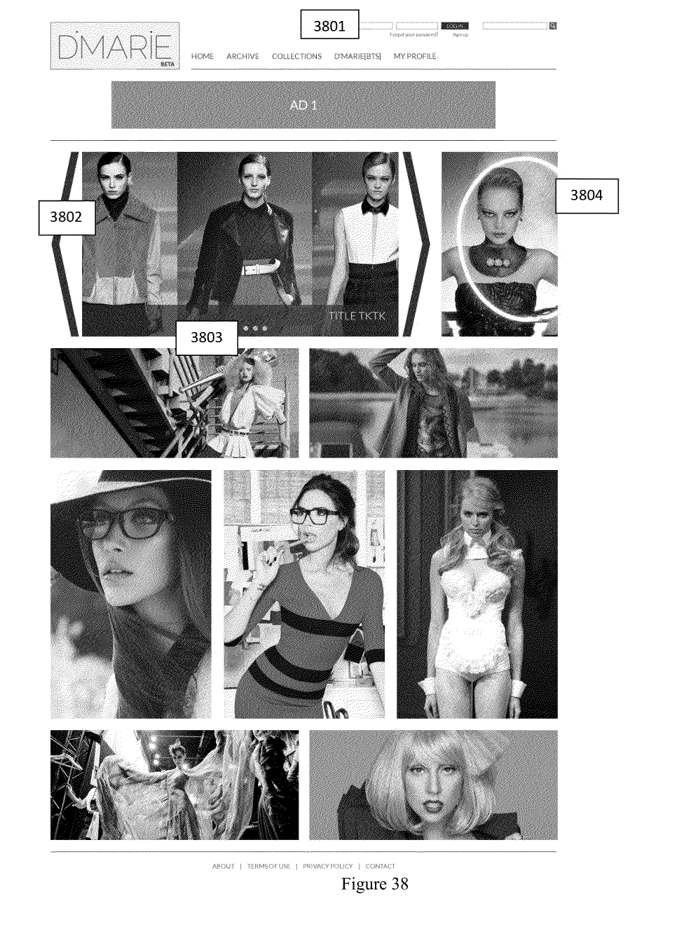

FIG. 38 is an exemplary embodiment of the D'Marie home page on the lifestyle platform. When a user opens the website in an internet browser, they have the option of logging into an existing account or signing up for a new account (3801). The side scroll (3802) frame contains three thumbnails that link a consumer to sponsor. With all of the images a gray box appears as the cursor passes over with the project information (3803). Each photo seen on the home page (3804) represents a rotating advertisement frame that brands can purchase from their industry profile.

Credentials

The “About Me” section of a Lifestyle Profile Page. This will include a profile photo to be uploaded by the user; basic information (name, profile name (for industry users), date established (for industry users), location, age); a blank field for the user to answer the question, “What is your style philosophy?” in 140 characters; social media links to the user's Facebook, Twitter, blog, and website; and a “Settings/Edit profile” button, only seen by the user, that allows them to go into editable profile mode and change profile settings/privacy.

FrontRow

A user can add a company, stylist, designer, or consumer to this section of “favorites.” They will then be “subscribed” to that profile and will receive updates from them on their LineUp regarding the added profile's style philosophy, new projects, and threads.

LineUp

A live news feed function of notifications and announcements. Any updated information that is generated by the user's FrontRow will be published here and show up in their profile. Live feeds will also display the user's own updates.

Threads

This section is a function for users to add garments that they like to their profile. Thread titles will be categorized by the type of garment (pencil skirt, blouse, boots, etc.). Users will not title the thread themselves as the garments are already categorized and will self-organize themselves into the correct title section. The sections show thumbnails of the garments, and once a user has added 5 garments to a certain thread it will be published and show up on their FrontRow's LineUp.

Project Portfolio

This section displays all of the projects an industry user has completed. When a consumer clicks on a specific project in this section they are directed to the project's profile page. A closed project can never be deleted from D'Marie but it can be “hidden” from a lifestyle page. When a company, designer, or stylist wants to take a project off of their lifestyle page they go into the “closed projects” section and click “hide project” button on the Final Production Form.

Collections

This will feature runway or look-book photos of designer's full collections. In addition, there will be biographical information on the designer and links to their personal website.

Style Influencers

This section is a collection of permanent “threads” for a user to list their favorite stylists, designers, brands (which will include celebrities), projects, looks, and articles. On any given brand, designer, stylist, or project profile a user can click on a widget that allows them to add the profile to one of their inspiration sections. The profile or page that is selected by a consumer will have a main photo and that thumbnail will appear in the inspiration section.

My D'Marie Wardrobe

This feature allows a consumer to add garments they already own, along with their recent online purchases, and share with other consumers. When a consumer is on a 3rd party site (i.e. Macys.com) and makes a purchase, the consumer will be able to click on a button on that Point of Sale (POS) page that will add the purchase to the consumer's “D'Marie Wardrobe”. Once a garment is entered into the consumer's personal wardrobe, the consumer will be able to later “tag” it in their Archive.

My Archive

A photo gallery of consumer uploaded images that include the garments from their D'Marie Wardrobe. A consumer can click on a button to upload a social photo of them wearing something in their D'Marie Wardrobe and will then be able to add a caption of the photo, as well as identify the item that they are wearing. Afterwards, the photo will be published to their profile for all users to see. In some embodiments, the photo must be of the consumer wearing something from their D'Marie Wardrobe; if they do not include an item from their D'Marie Wardrobe in the photo, it will not be published.

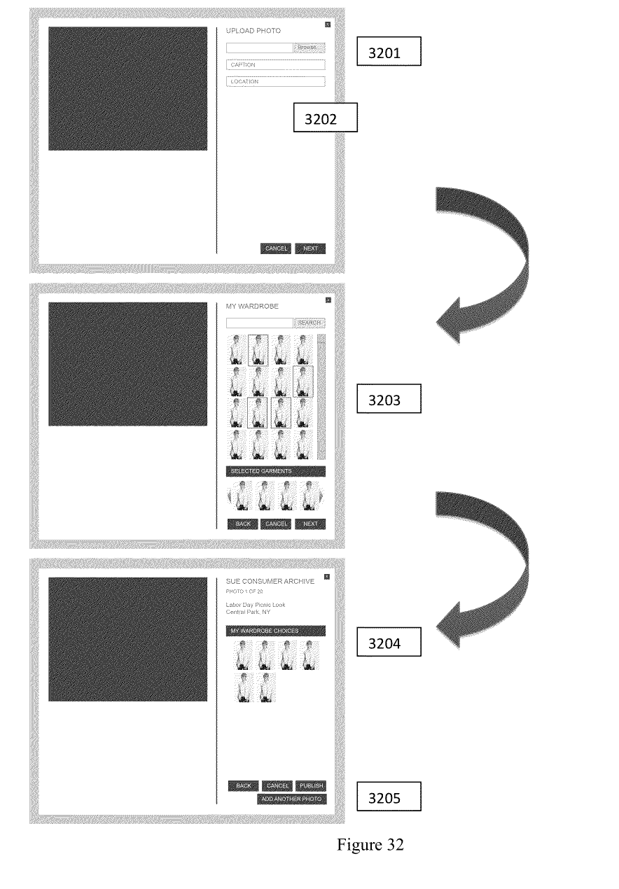

FIG. 32 is an exemplary embodiment of the My Archive process, which allows users to upload personal photos and attach garment profiles from the D'Marie Wardrobe database. Users select a photo to upload from a local server (3201) by clicking the “Browse” button. The user can choose to caption the photo and add the location of where the photo was taken (3202) then click “next” button to continue through the process. In the next window, the user selects garment(s) profiles from My Wardrobe database (3203). The user can review their selection and make changes (3204), cancel the action, publish to their public profile or add another photograph to the selection (3205).

Product Carousels

Product carousels are a type of advertising which link consumers to similar garments as the one they are currently looking at. It connects to 3^{rd} party retailers by hosting specific items in a set of boxes that the consumer can then click on to buy in a new tab. These carousels will be featured on all garment and project pages, as well as designer and brand profile pages.

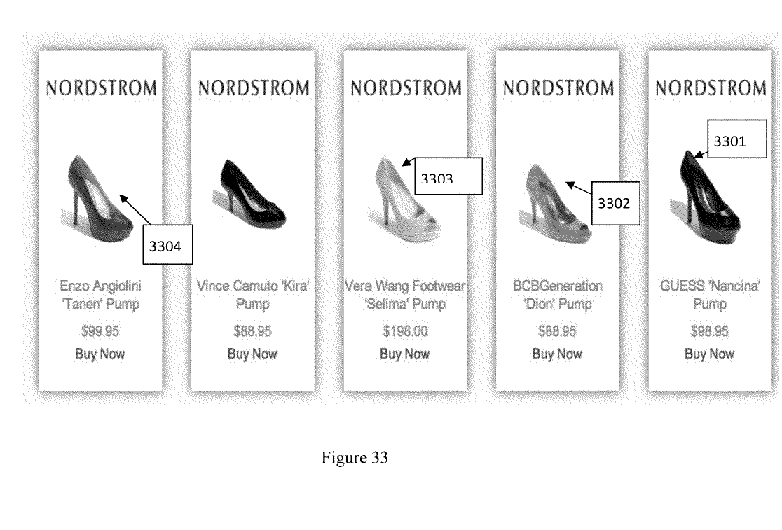

FIG. 33 is an exemplary embodiment of a product carousel advertising opportunity. A user can upload carousel information and photos via their industry profile. The retail logo of the product (3301) mentioned in the carousel appears at the top of the carousel box. An image of the product being sold (3302) in the carousel is displayed in the center of the box. A “Buy Now” link (3303) to the retail URL appears at the bottom of the carousel. The title and the retail price of the product (3304) appear underneath the image in the carousel.

As an affiliated advertising opportunity, designers and clients (brands) can place garments or products they're associated with and that are for sale on an e-commerce platform on their lifestyle profile. The product carousels will only appear in profiles that have purchased the ad opportunity. They will be able to manage this on their industry platform profile.

Blog

D'Marie's blog is a fashion-centered platform that allows direct interaction with platform users in length about fashion trends, street style, fashion news, industry developments, and new website features. The platform provide readers with business perspective of the industry via interviews with various industry influencers and designers, and case studies on fashion trends both today and throughout history. A goal of the blog is to display relevant content to the site's mission in a professional manor. The system can be configured to host articles posted from guest bloggers and editors so the platform's reach can be expanded to the existing blogger community and their readers. The platform can offer links to Facebook and Twitter so users can share blog posts with their friends on the selected social media platform.

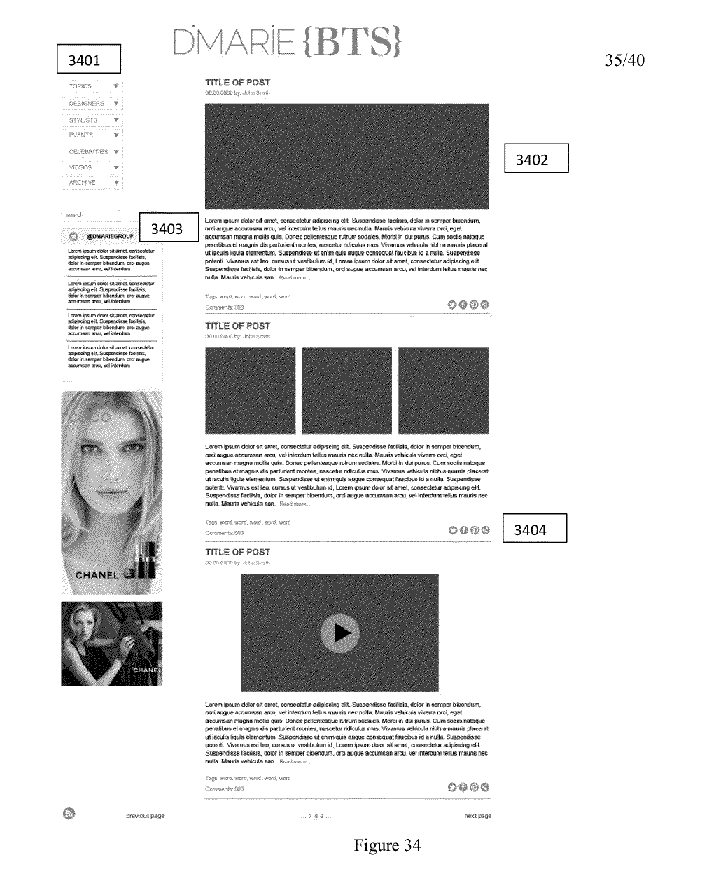

FIG. 34 is an exemplary embodiment of the D'Marie BTS blog, which displays articles written and uploaded by D'Marie staff. Users can search through blog posts by category (3401), as each blog will be categorized with certain tags. Blog posts are displayed with a photo and text below (3402). The most recent blog post will appear at the top of the page; the purple box indicates where a picture frame. The text underneath the picture is a partial display of the full blog post. When the blog post title is clicked the user will able to read the entire blog post. A live Twitter feed of the D'Marie Twitter account (3403) appears on the left side of the blog home page and serves as a separate update on news related to the company. Users can share blog posts using various social media outlets (3404) by clicking on the appropriate icons. Users can use the toolbar at the bottom to scroll to previous and next pages of the blog.

### Lifestyle Profile Types

Designer

A designer's lifestyle profile will present all of their information from the industry side (their collections, projects, individual garment pages), and more. It will be consumer-friendly and engaging, in order to make it the most effective marketing tool possible. Included in the Designer Profile are the following features, which have been detailed in previous sections: Credentials, FrontRow, LineUp, Project Portfolio, Collections, Style Influencers, and Product Carousels.

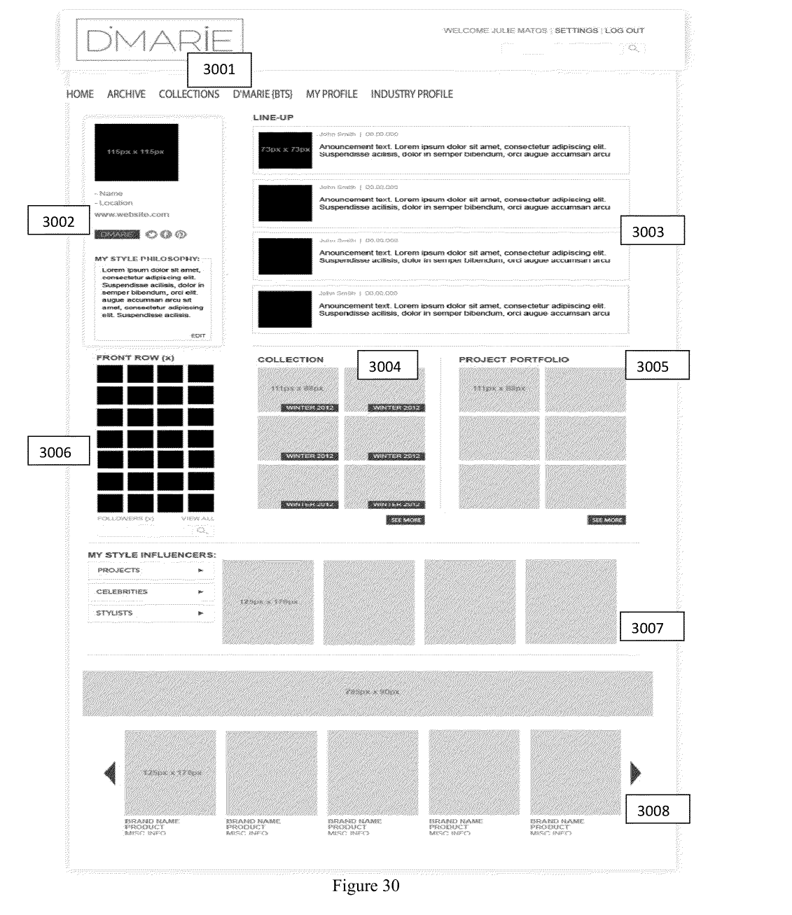

FIG. 30 is an exemplary embodiment of a designer's public profile page on the lifestyle platform. The user is able to access other sections of the lifestyle platform by using the toolbar (3001), including their industry profile. The Credential section of the profile displays information entered into the company settings form (3002). The Line-Up feature (3003) is a real-time feed of information and notifications from users that they have subscribed to, in addition to displaying notifications of their own published content. The designer profiles feature collections (3004); a thumbnail of a garment from the collection is a link to view the full collection on a sub-landing. The Project Portfolio (3005) displays thumbnails of any project that the designer has published. The thumbnails are links to that specific project page. The Front Row (3006) features the other user profiles that the designer has subscribed to. A designer user can display any project, celebrity, collection, or stylist as a “Style Influencer” (3007) by clicking the [+Influencer] widget on the desired page or profile. Designer accounts have the option of purchasing advertising space on their public profile page in the form of product carousels (3008), which can display product images, information and urls that link the consumer through to their own website where a purchase can be made.

Stylist

Stylist Profiles provide stylists with a medium to expose consumers to their projects and gain more publicized credit than they would have normally gained. It is a branding opportunity for stylists to demonstrate their talent and gain notoriety among the public. Included in the Stylist Profile are the following features, which have been detailed in previous sections: Credentials, FrontRow, LineUp, Project Portfolio, and Style Influencers.

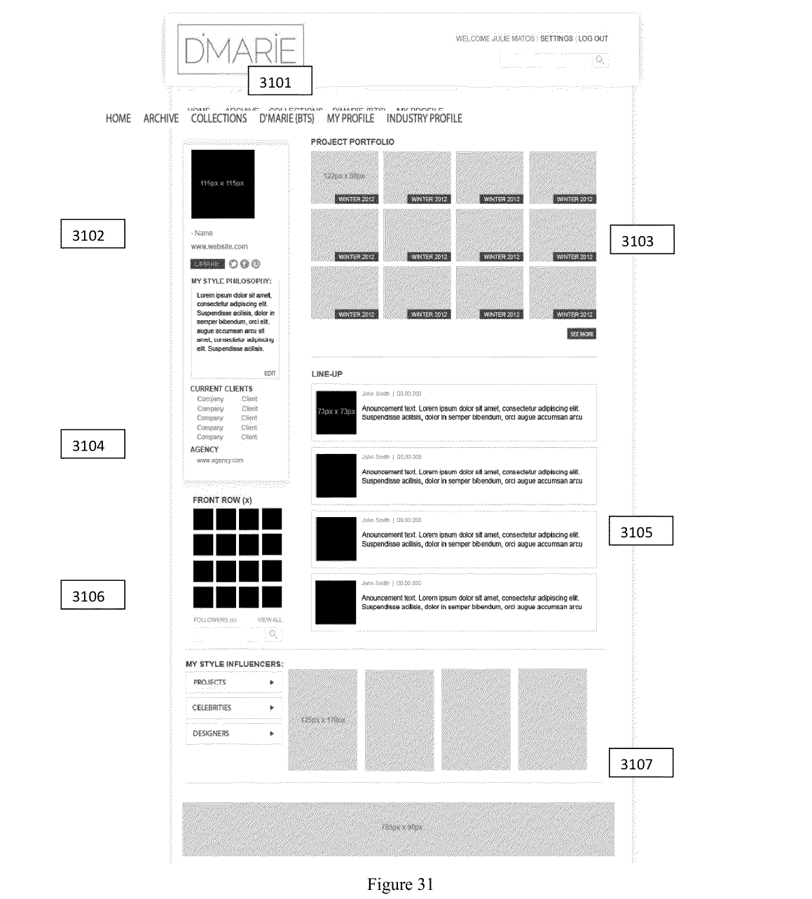

FIG. 31 is an exemplary embodiment of a stylist profile on D'Marie's lifestyle platform. The lifestyle profile for industry users features a toolbar (3101) for accessing both profiles, as well as other destinations on the site. The Credentials (3102) of the stylist user are displayed, including a photo, name, website, style philosophy, and social media links. The Project Portfolio (3103) displays images of all projects the stylist has styled for a client and published on the industry server and links any user clicking on the image to the corresponding project page. The Current Clients section (3104) displays the five most recent brands that have commissioned the stylist to complete projects. Stylist users have a Line-Up section (3105) which displays updates from their Front Row and will also serve as a platform to let them publicize their own projects when published. The Front Row (3106) features the other profiles that the stylist has subscribed to. The user can also identify any project, celebrity, or designer as a “Style Influencer” (3107) and add it to their profile by clicking the [+Influencer] widget on the desired page or profile.

Consumer

Consumer profiles let any non-industry user engage in D'Marie's content. Consumers will be able to not only search for projects in the archive and discover the clothing their favorite characters and celebrities are wearing, but also interact with their fashion-focused individuals. Included in the Consumer Profile are the following features, which have been detailed in previous sections: Credentials, FrontRow, LineUp, Threads, Style Influencers, My D'Marie Wardrobe, and My Archive.

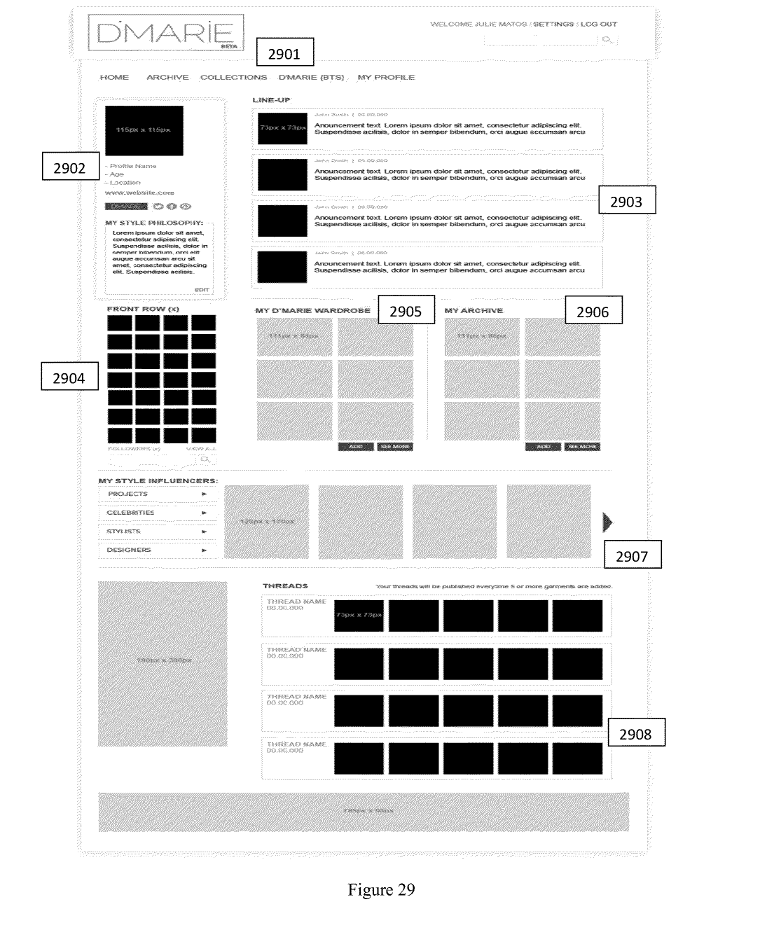

FIG. 29 is an exemplary embodiment of the Consumer Lifestyle Profile that a consumer user will see upon logging into the system from the lifestyle website. Consumer accounts access all of the sections of the website by clicking on the buttons in a profile toolbar. (2901) Consumers can edit personal information by clicking the “edit” button and using the edit functions on the profile (2902). They can also add links to social media sections and update a style philosophy by selecting the “settings” page of the profile in the toolbar. The consumer's Line-Up; (2903) a real-time feed of notifications generated from user profiles that they have subscribed to by joining their Front Row or placing a page into the “My influencer” section. The “Front Row” database (2904) displays thumbnail images of other user profiles that the user has subscribed to. Clicking on a thumbnail will direct the consumer to that user's profile page. This database also stores the thumbnails of the user profiles that have chosen to follow the user's page. “My D'Marie Wardrobe” (2905) database and process enables a consumer to add garments that they already own by uploading a photo and garment details to a form after clicking the “add” button under the section. Thumbnails of the images appear immediately after upload. Consumers can add personal photos of themselves and friends in the “My Archive” (2906) database. Thumbnails of project pages, garment pages, user profiles, articles, and photos that the consumer has designated as a “Style Influencer” will be stored and displayed in the “My Influencer” section of individual consumer profiles (2907). A user can add a page or person to the “My style influencer” section by clicking on the [+Influencer] icon on any page. Clicking on the thumbnail will lead you to that particular garment or project profile. Consumers can also sort through these images by category. The Thread (2908) allows consumers to add garments to their profile that are not part of their My Wardrobe by clicking on the [+Thread] icon on any garment profile.

Brand

A Brand Profile can serve as a platform for companies to connect with consumers, engage the audience, and cultivate a more interactive group of users by making their advertisements more visually appealing. Brands will become more aware of their styling choices when producing commercials, and in turn, consumers will grow more attentive and actively search for the advertisements they see and like. Included in the Brand Profile are the following features, which have been detailed in previous sections: Credentials, FrontRow, LineUp, Project Portfolio, Style Influencers, and Product Carousels.

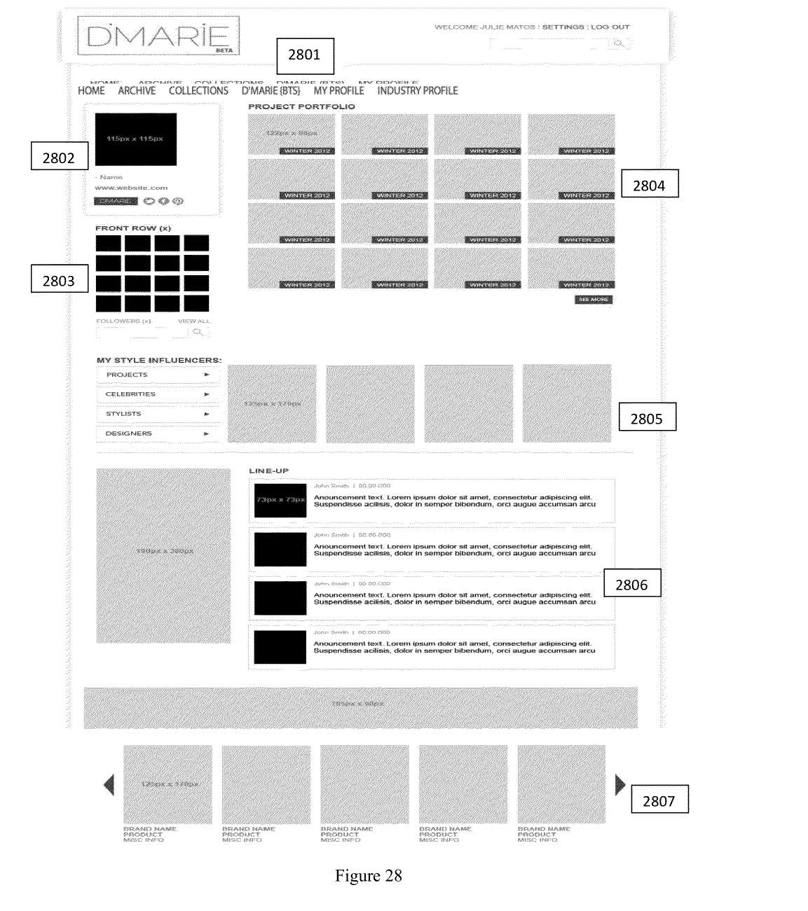

FIG. 28 is an exemplary embodiment of a brand profile on D'Marie's lifestyle platform. The lifestyle profile for industry users features a toolbar (2801) for accessing both profiles, as well as other destinations on the site. The Credentials (2802) of the brand user are displayed, including a photo or logo, the brand name, a website, and social media links. The Front Row (2803) features the other profiles that users on the brand account have subscribed to. The Project Portfolio (2804) displays images of all projects the brand has published on the industry server and links any user clicking on the image to the corresponding project page. The brand can also identify any project, celebrity, stylist, or designer as a “Style Influencer” (2805) and add it to their profile by clicking the [+Influencer] widget on the desired page or profile. Brand users have a Line-Up section (2806) which displays updates from their Front Row and will also serve as a platform to let them publicize their own projects when published. Brand accounts have the option of purchasing advertising space on their public profile page in the form of product carousels (2807), which can display products of the brand and link the consumer through to their own website where a purchase can be made.

Database

This database for consumers includes all of the completed project profiles, garment profiles, and lifestyle pages of designers, stylists, and companies. A consumer can use general sortable terms in a free-form search bar or use the advanced search tool to narrow their results. The results display any data that matches the sortable terms entered by a user.

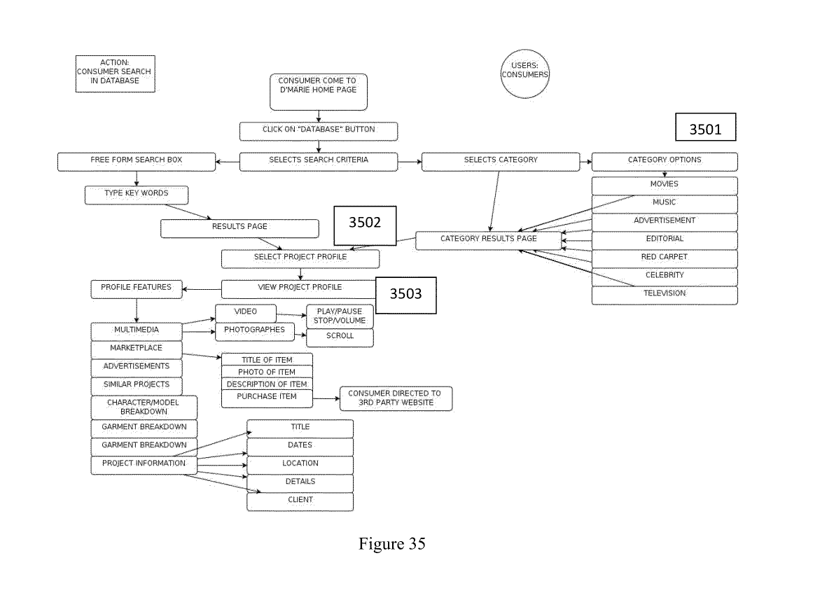

FIG. 35 is an exemplary embodiment of the public database on the lifestyle website and the tag recognition of user inquiries. This database contains every public garment profile, closed project profile, and user profile stored in the website. The database sorts pages by tags such as project category, user name, project name, garment type, etc. (3501). The matching pages appear in the results section and are represented by a thumbnail of a photo from the page (3502). When a user clicks on the thumbnail they are taken to the full page to view all of the information of the garment, project, or user (3503).

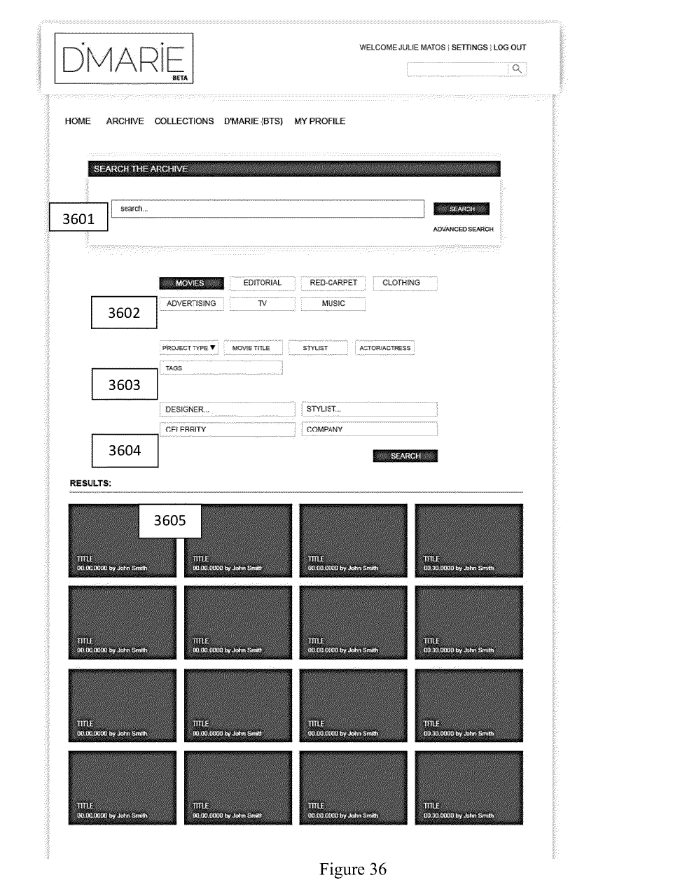

FIG. 36 is an exemplary embodiment of the public database user interface on the lifestyle website and a user's search capabilities. This database contains every public garment profile, closed project profile and user profile stored in the website. Users can search for any page via a free-form search tool (3601) or can execute an advance search for a project by selecting a specific project category (3602). When a user clicks on a project category, unique sub-search fields appear that are specific to that category (3603). A user can search for public industry user pages by entering a name into the specific field (3604). The matching pages appear in the results section and are represented by a thumbnail of a photo from the page (3605).

Project Page

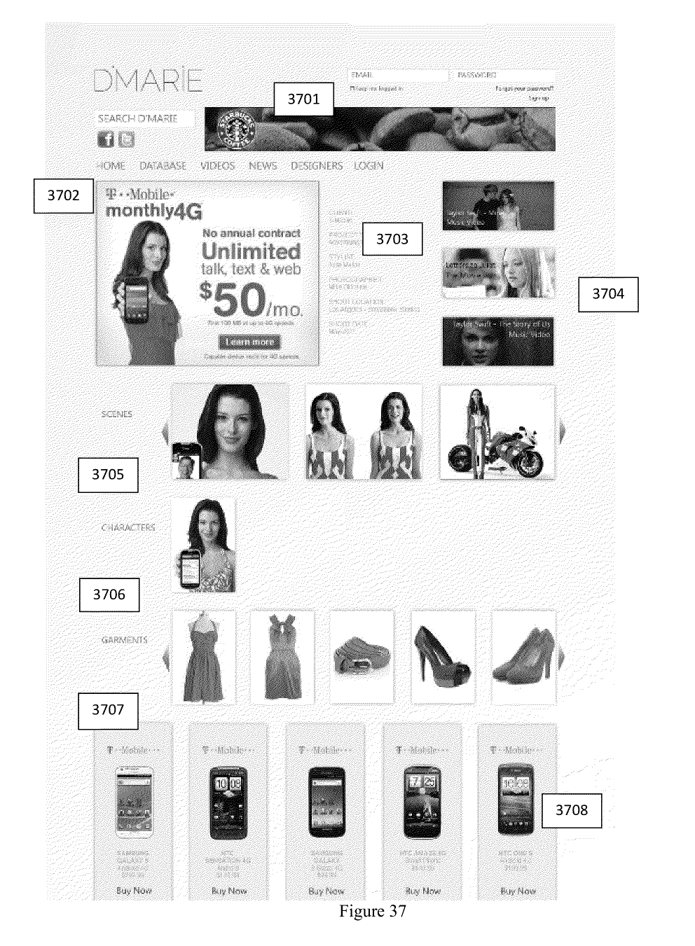

FIG. 37 is an exemplary embodiment of a project page. Project pages display completed projects from the project database. At the top of the page a user can always log into their personal account (3701). The toolbar displays links to other sections of the site (3702). The project's multi-media files are displayed (3703) in the media frame next to the project details. (name of the project, client, stylist, photographer, location of the shoot, models, and the shoot date when applicable). Thumbnail images of similar project content (3704 appears to the right side and, when clicked, links a user to the separate project page. Below the final project media frame is a display of all the photos the client has attached to each “certified look” custom pullsheet in the Final Production Form. (3705). Thumbnails of all the models(s) involved in the project (3706) are displayed, matching the model information that the stylist details in the project form. A scrollable list of all garments used in the project (3707) is displayed, matching the information that the client verifies for each certified look custom pullsheet. When a user clicks on a specific scene only the thumbnails of models and garments associated with that certified look appear. All other thumbnails disappear. A product carousel (3708) displays the information uploaded in the advertising management section of a company user's profile.

Project Breakdown

Project Multimedia Section—Production photos or a video of the final project. Depending on the project, this could be a video that was archived or a photo gallery with production photos of the project or event.

Project Info—Title, Project Category, Company/Client, Project date, location, Stylist, additional details.

Garments archived in project—this is a section on the page that shows all of the garments that have been archived in the project.

Social Media—widget icons links so people can add (“thread”) it to their profiles, as well as existing social media sites.

Models/scenes

Models in Project—a section for consumers to click on different characters, models, or celebrities used in one project

Scenes—depicts a still shot for different sets of garments throughout the project

Product carousels

Product “Marketplace” Section—This is an advertising section for products that are related to the project. The consumer can click on a link and be sent to the online retailer. The images that appear in this section will be links to a 3rd party website to purchase the items (for example, an archived Lady Gaga music video might have a link to M.A.C. to purchase her make-up or iTunes to buy her music).

Similar Projects

This is a section on the page where people can click to view similar projects to the one they are currently viewing.

Garment Page

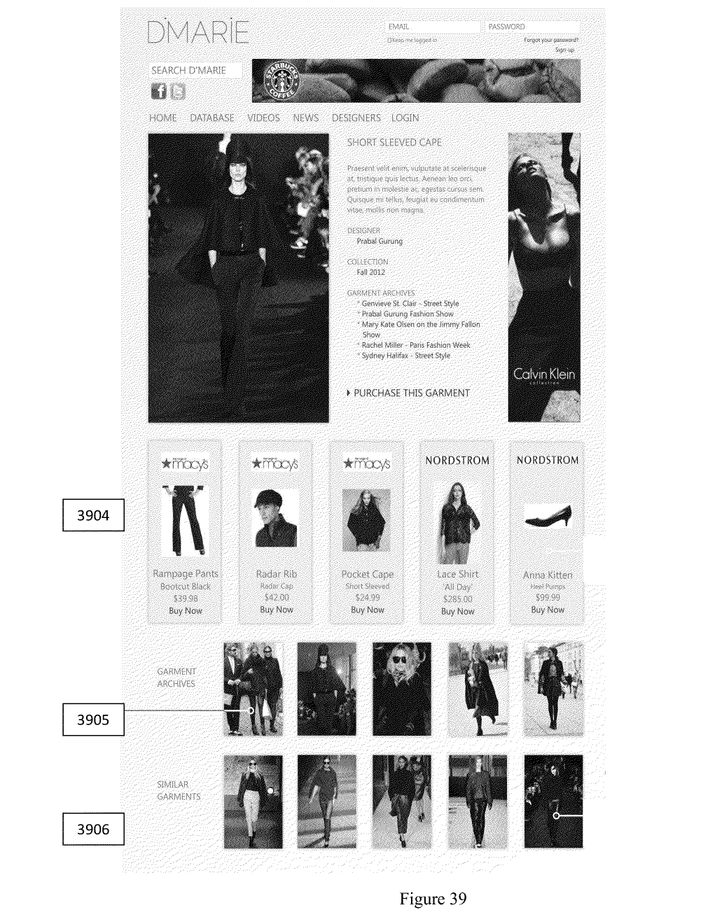

FIG. 39 is an exemplary embodiment of a garment profile on the lifestyle platform. At the top of the page is a toolbar for various sections on the site (3901). The garment information is found to the right of the garment image (3902) and displays the name of the garment, along with a description, the designer, the collection it is featured in, and the projects it can be found in with links to each. The user has the option to click a link, “Purchase this Garment,” to be taken to a third-party website where the garment is available for purchase. Below this information is a product carousel (3904) with items that are similar to the featured garment and available for purchase at various online retailers. The Garment Archive section (3905) displays the images for projects that have utilized the garment and provide links through to each of the project pages. The Similar Garments section (3906) displays other garment profile images from the D'Marie Archive that are similar to the viewed garment and provides links through to each of the garment profiles.

Product Information: Garment Photo Gallery—A user will get to this page by clicking through a project page or directly from a search results. The default garment image(s) will be from the collection, but this photo gallery can be one image or several images from the projects it has been used in.

Garment information: designer, collection, URL (to purchase), color, fabric, pattern title, retail price, garment details (uploaded by designer)

Designer collection—link to the photo gallery of the garments' collection

Other garments worn (same project & model)—this section shows thumbnails of other garments worn by the same model in the same project that a consumer can click to view.

Consumer Social Media—icon links for them to add to their “threads” section of their profiles, or share on social media sites such as Facebook, Twitter, Dig, etc.

Garment History: Other projects the garment have been used in—This is a section of thumbnails that a consumer can click on to see the garment in other projects

Similar Garment Section: This section shows other garments on the D'Marie website that are similar to the garment currently being viewed. Each image will link to another garment page.

Product carousels: This is an advertising section, or “marketplace,” for garments that are related to the original archived garment. The consumer can click on a link and be sent to the retailer. The images that appear in this section will be links to a 3rd party website to purchase the items. (i.e. If we archived a Dior dress that costs $12K there will be links to other dresses that look alike but are available at various price points).

Consumers can search for and view garment profiles based on any information associated with the garment profiles. For example, consumers can search for garments based on associated garment information (e.g., designer), the garment history, media events (e.g., where the garment has been used), wearing party (e.g., which models, celebrieties, friends, etc. have worn the garment), and/or any other information cataloged with the garment profiles during the life cycle of the garment as it is processed and updated by the system.

Complete Lifestyle Platform

The Lifestyle Platform's content is almost entirely generated by the industry users via their industry profiles. Additionally, the profile pages that each user can create add a sense of community to the site and let both industry users and consumers form networks based around their personal fashion and style preferences. Consumers visiting D'Marie can search and shop specific archived projects via the Archive database, manage a personal profile, receive updates about their favorite celebrities, designers, and stylists via their live newsfeed and self archive garments that appear in their personal photo albums. Archived projects are published and allow for consumers to discover the exact garments worn by a character or celebrity, or shop for similar garments at various price points.

On each industry users' public profile page, their project credits show up and are presented to consumers via a user interface which lets the individual interact with the projects; click through multiple scenes, garments, and characters; and then both shop and share the various aspects. Through this exposure, industry users gain valuable consumer views and are able build, manage and monetize from their unique community of fashion enthusiasts.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

Although the above description details an embodiment of the invention (e.g., a web server coupled with databases and remote computers), it should be understood that the techniques and concepts are applicable to other information platform and database systems in general. Thus the invention may be embodied in other specific forms without departing from the spirit or essential characteristics thereof. The embodiments disclosed herein are therefore to be considered in respects as illustrative and not restrictive. For example, in another embodiment, the platform and database design could be modified for use in the music industry so that musicians could upload and track their music through various parties as they are placed in media events and subsequently sold to consumers. In another embodiment, the platform and database design could be applied to the interior design industry.

What is claimed is:

1. A computerized method for providing a fashion platform, the method comprising:
receiving, by a web server, a set of garment profiles, and storing the set of garment profiles in a database, wherein each garment profile defines a garment being offered for sale by an associated garment designer profile;
receiving, by the web server, a set of new stylist projects, wherein each new stylist project is received from an associated stylist's computing device and includes data indicative of:
one or more garment profiles from the set of garment profiles;
a model profile for a model; and
a media event;
updating, by the web server, for each new stylist project, each of the one or more garment profiles associated with the new stylist project to reflect data indicative of at least one of the remaining one or more garment profiles associated with the new stylist project, the model profile, the media event, or any combination thereof;
receiving, by the web server, data indicative of a request from a consumer's computing device to view a requested set of garment profiles associated with a particular media event, a particular stylist profile, a particular model profile, a particular garment designer profile, or any combination thereof; and
transmitting, by the web server, a web page to the consumer's computing device comprising data indicative of the requested set of garment profiles.

2. The method of claim 1, wherein receiving the set of new stylist projects comprises, for each new stylist project:
generating a master pullsheet for the new stylist project, wherein the master pullsheet is configured to be associated with one or more garment profiles for the new stylist project;
receiving data indicative of a request from the stylist computing device to add a first garment profile from the set of garment profiles to the master pullsheet; and
associating the first garment profile with the master pullsheet.

3. The method of claim 2, further comprising:
receiving data indicative of a request from the stylist's computing device to close the new stylist project; and
generating a final production form based on the new stylist project and the master pullsheet, and storing the final production form in the database.

4. The method of claim 1, further comprising:
receiving, from the consumer computing device, data indicative of a use of a garment associated with a garment profile; and
associating the garment profile with a consumer profile associated with a consumer using the consumer computing device.

5. The method of claim 1, further comprising:
receiving, from the consumer's computing device, data indicative of a consumer purchasing a garment associated with a garment profile; and
associating the garment profile with a consumer profile associated with the consumer.

6. The method of claim 1, further comprising:
receiving data indicative of a request from the stylist's computing device to order a garment associated with a garment profile;
determining a stylist profile associated with a stylist operating the stylist computing device is networked with a designer profile associated with the garment profile;
transmitting the request to the associated designer profile;
receiving data indicative of a designer associated with the designer profile accepting the request.

7. The method claim 1, wherein transmitting the web page comprises:
transmitting a first hyperlink to the consumer's computing device configured to, upon actuation, load a first web page provided by a designer of a garment of a garment profile from the requested set of garment profiles so that a consumer using the consumer computing device can purchase the garment from the designer; or
transmitting a second hyperlink to the consumer's computing device configured to, upon actuation, load a second web page provided by a second designer of a reduced-price garment generated based on the garment so that the consumer using the consumer computing device can purchase the reduced-price garment from the designer, or both.

8. The method of claim 1, further comprising receiving data indicative of a request to create a new designer profile from a designer's computing device, the new designer profile comprising a set of custom garment profiles, each custom garment profile being associated with a garment designed by a designer associated with the new designer profile.

9. The method of claim 1, further comprising:
storing a credit rating for each designer profile associated with the set of garment profiles; and
updating, for each association of a first garment profile with the stylist profile, the model profile, the consumer profile, or any combination thereof, the credit rating for a first designer profile associated with the first garment profile.

10. The method of claim 1, further comprising receiving data indicative of a request to create a new consumer profile for a consumer operating a computing device, the new consumer profile comprising preferences determined by the consumer based on profiles selected from the group consisting of a set of stylist profiles, a set of garment profiles, a set of model profiles, and a set of brand profiles.

11. The method of claim 1, further comprising receiving data indicative of a request to create a new model profile for a model from a computing device, wherein the new model profile comprises a model name, a profile picture, and a set of stylist projects associated with the model.

12. The method of claim 11:
further comprising storing a credit rating for the new model profile; and
updating, for each association of the new model profile with a stylist project, the credit rating for the new model profile.

13. The method of claim 11, further comprising:
storing the model profile in the database; and
storing additional information associated with the model profile for a stylist profile in a second database, wherein a remaining set of stylist profiles cannot access the additional information.

14. A computerized fashion platform comprising:
a database; and
a web server coupled to the database having
one or more interfaces configured to provide communication with a set of remote computers; and
a processor, in communication with the one or more interfaces and the database, and configured to run a module stored in memory that is configured to cause the processor to:
receive a set of garment profiles, and storing the set of garment profiles in the database, wherein each garment profile defines a garment being offered for sale by an associated garment designer profile;
receive a set of new stylist projects, wherein each new stylist project is received from an associated stylist's computing device and includes data indicative of:
one or more garment profiles from the set of garment profiles;
a model profile for a model; and
a media event;
update, for each new stylist project, each of the one or more garment profiles associated with the new stylist project to reflect data indicative of at least one of the remaining one or more garment profiles associated with the new stylist project, the model profile, the media event, or any combination thereof;
receive data indicative of a request from a consumer's computing device to view a requested set of garment profiles associated with a particular media event, a particular stylist profile, a particular model profile, a particular garment designer profile, or any combination thereof; and
transmit a web page to the consumer's computing device comprising data indicative of the requested set of garment profiles.

15. A non-transitory computer readable medium having executable instructions operable to cause an apparatus to:
receive a set of garment profiles, and storing the set of garment profiles in a database, wherein each garment profile defines a garment being offered for sale by an associated garment designer profile;
receive a set of new stylist projects, wherein each new stylist project is received from an associated stylist's computing device and includes data indicative of:
one or more garment profiles from the set of garment profiles;
a model profile for a model; and
a media event;
update for each new stylist project, each of the one or more garment profiles associated with the new stylist project to reflect data indicative of at least one of the remaining one or more garment profiles associated with the new stylist project, the model profile, the media event, or any combination thereof;
receive data indicative of a request from a consumer's computing device to view a requested set of garment profiles associated with a particular media event, a particular stylist profile, a particular model profile, a particular garment designer profile, or any combination thereof; and
transmit a web page to the consumer's computing device comprising data indicative of the requested set of garment profiles.
